(19) United States
(12) Patent Application Publication
(10) Pub. No.: US 2026/0197780 A1
(43) Pub. Date: Jul. 9, 2026

(54) DATA TRANSMISSION METHOD, APPARATUS, DEVICE, AND STORAGE MEDIUM

(71) Applicant: GUANGDONG OPPO MOBILE TELECOMMUNICATIONS CORP., LTD., Dongguan (CN)

(72) Inventors: Jinyu ZHANG, Dongguan (CN); Weijie XU, Dongguan (CN)

(73) Assignee: GUANGDONG OPPO MOBILE TELECOMMUNICATIONS CORP., LTD., Dongguan (CN)

(21) Appl. No.: 19/555,768

(22) Filed: Mar. 3, 2026

Related U.S. Application Data
(63) Continuation of application No. PCT/CN2023/126029, filed on Oct. 23, 2023.

(51) Int. Cl. H04W 56/00; H04W 72/044

(52) U.S. Cl. CPC H04W 56/001; H04W 72/044

(57) ABSTRACT

A data transmission method is provided. The data transmission method includes that: a zero-power device receives a control signaling, here, the control signaling is used for triggering the zero-power device to perform time-frequency synchronization and for indicating time-frequency resources for data transmission. Further, a zero-power device and a network device are provided.

### CROSS-REFERENCE TO RELATED APPLICATION(S)

This application is a continuation of International Application No. PCT/CN2023/126029 field on Oct. 23, 2023, the entire disclosure of which is hereby incorporated by reference in its entirety.

### RELATED ART

With the continuous evolution of wireless communication technologies, Internet of Things (IoT) technology has been applied across various aspects of production and daily life. In zero-power IoT, zero-power devices have very simple radio frequency and baseband circuits, and thus have many advantages such as small size, light weight, low cost, long service life, and maintenance-free.

Due to the limited performance of zero-power devices, the duration of synchronization procedure of the zero-power devices may range from a few milliseconds to several hundred milliseconds, and the synchronization procedure is related to data transmission. The implementation of synchronization procedure and data transmission for the zero-power devices still requires further discussion and research.

### SUMMARY

The present disclosure relates to the field of zero-power communications, and provides a data transmission method, a zero-power device, and a network device. The technical solutions are as follows.

According to a first aspect of the present disclosure, there is provided a data transmission method performed by a zero-power device. The method includes the following operations.

A control signaling is received. Here, the control signaling is used for triggering the zero-power device to perform time-frequency synchronization and for indicating time-frequency resources for data transmission.

According to a second aspect of the present disclosure, there is provided a data transmission method performed by a network device. The method includes the following operations.

A control signaling is sent. Here, the control signaling is used for triggering the zero-power device to perform time-frequency synchronization and for indicating time-frequency resources for data transmission.

According to a third aspect of the present disclosure, there is provided a zero-power device.

The zero-power device includes a processor, and a memory for storing instructions that, when executed by the processor, cause the zero-power device to receive a control signaling. Here, the control signaling is used for triggering the zero-power apparatus to perform time-frequency synchronization and for indicating time-frequency resources for data transmission.

According to a fourth aspect of the present disclosure, there is provided a network device.

The network device includes a processor, and a memory for storing instructions that, when executed by the processor, cause the network device to send a control signaling. Here, the control signaling is used for triggering a zero-power device to perform time-frequency synchronization and for indicating time-frequency resources for data transmission.

### BRIEF DESCRIPTION OF THE DRAWINGS

In order to more clearly explain the technical solutions in the embodiments of the present disclosure, the accompanying drawings that need to be used in the description of the embodiments will be briefly introduced below. It is apparent that the accompanying drawings in the following description are only some embodiments of the present disclosure, and for those skilled in the art, other drawings can be obtained from these accompanying drawings without making creative labor.

FIG. 1 is a diagram of a zero-power communication system provided by an exemplary embodiment of the present disclosure.

FIG. 2 is a diagram of radio frequency power harvesting provided by an exemplary embodiment of the present disclosure.

FIG. 3 is a diagram of a backscatter communication process provided by an exemplary embodiment of the present disclosure.

FIG. 4 is a diagram of resistive load modulation provided by an exemplary embodiment of the present disclosure.

FIG. 5 is a diagram of encoding manners provided by an exemplary embodiment of the present disclosure.

FIG. 6 is a diagram of uplink transmission scheduling in a Long Term Evolution (LTE) system provided by an exemplary embodiment of the present disclosure.

FIG. 7 is a diagram of transmission scheduling in a Wireless Local Area Network (WLAN) system provided by an exemplary embodiment of the present disclosure.

FIG. 8 is a flowchart of a data transmission method provided by an exemplary embodiment of the present disclosure.

FIG. 9 is a flowchart of a data transmission method provided by an exemplary embodiment of the present disclosure.

FIG. 10 is a flowchart of a data transmission method provided by an exemplary embodiment of the present disclosure.

FIG. 11 is a diagram of a process of scheduling data transmission provided by an exemplary embodiment of the present disclosure.

FIG. 12 is a diagram of a signaling transmission process provided by an exemplary embodiment of the present disclosure.

FIG. 13 is a flowchart of a data transmission method provided by an exemplary embodiment of the present disclosure.

FIG. 14 is a schematic diagram of a process of scheduling data transmission provided by an exemplary embodiment of the present disclosure.

FIG. 15 is a block diagram of a zero-power apparatus provided by an exemplary embodiment of the present disclosure.

FIG. 16 is a block diagram of a network-side apparatus provided by an exemplary embodiment of the present disclosure.

FIG. 17 is a structural diagram of a communication device provided by an exemplary embodiment of the present disclosure.

### DETAILED DESCRIPTION

In order to clarify the objectives, technical solutions, and advantages of the present disclosure, the embodiments of the present disclosure will be described in further detail below with reference to the accompanying drawings. Exemplary embodiments, examples of which are illustrated in the accompanying drawings, will be described in detail herein. Where the following description refers to the drawings, the identical numerals in different drawings denote the same or similar elements unless otherwise indicated. The following exemplary embodiments do not represent all embodiments consistent with the present disclosure. Rather, they are merely examples of devices/apparatuses and methods consistent with some aspects of the present disclosure as detailed in the appended claims.

The terminology used herein is for the purpose of describing particular embodiments only, and is not intended to limit the present disclosure. As used in the present disclosure and the appended claims, the singular forms “a,” “the,” and “said” are also intended to include the plurality of forms unless the context clearly indicates otherwise. It should also be understood that the term “and/or” as used herein refers to and includes any or all possible combinations of one or more associated listed items.

It should be understood that although the terms “first”, “second”, “third”, etc. may be employed in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein may be interpreted as “in a case where” or “when” or “in response to determining.”

The technical solutions described in some embodiments of the present disclosure can be applied to various communication systems, such as: Global System for Mobile Communications (GSM), Code Division Multiple Access (CDMA) systems, Wideband Code Division Multiple Access (WCDMA) systems, General Packet Radio Service (GPRS) systems, Long Term Evolution (LTE) systems, Advanced Long Term Evolution (LTE-A) systems, New Radio (NR) systems, evolution of NR systems, LTE-based access to unlicensed spectrum (LTE-U) systems, NR-based access to unlicensed spectrum (NR-U) systems, Non-Terrestrial Networks (NTN) systems, Universal Mobile Telecommunication System (UMTS), Wireless Local Area Networks (WLAN) systems, Wireless Fidelity (WiFi) systems, 5th Generation Mobile Communication Technology (5G) systems, cellular Internet of Things systems, cellular passive Internet of Things systems, subsequent evolution systems of the 5G NR systems, 6th Generation Mobile Communication Technology (6G) systems and subsequent evolution systems.

It should be understood that “5G” may also be referred to as “5G NR” or “NR” in some embodiments of the present disclosure.

It should be understood that in the description of the embodiments of the present disclosure, the term “correspondence” may mean that there is a direct correspondence or indirect correspondence between the two, or may mean that there is an association relationship between the two, or may mean a relationship between indicating and being indicated, configuring and being configured, or the like.

In the embodiments of the present disclosure, “predefined/preset/preconfigured” may be realized by pre-storing corresponding codes, tables, or other manners that can be used to indicate relevant information in a device (including, for example, a terminal device and a network device), and the present disclosure does not limit the specific implementation thereof. For example, predefined may refer to being defined in a protocol.

In the embodiments of the present disclosure, the “protocol” may refer to a standard protocol in the field of communications, and may include, for example, an LTE protocol, an NR protocol, and related protocols to be applied in a future communication system, and the present disclosure does not limit this.

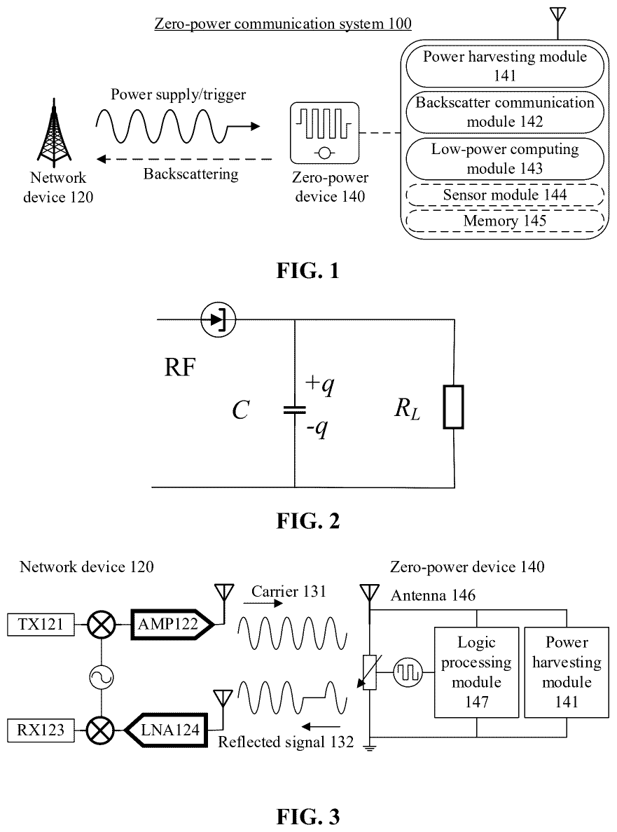

FIG. 1 illustrates a diagram of a zero-power communication system 100 provided by an exemplary embodiment of the present disclosure, and the zero-power communication system 100 includes a network device 120 and a zero-power device 140.

The network device 120 is configured to transmit a radio power supply signal and a downlink (DL) communication signal to the zero-power device 140, and to receive a backscattered signal from the zero-power device 140. The zero-power device 140 is also referred to as an Ambient power enabled Internet of Things (Ambient IoT) device, and includes a power harvesting module 141, a backscatter communication module 142, and a low-power computing module 143. The power harvesting module 141 may harvest power carried by radio waves in space, for driving the low-power computing module 143 of the zero-power device 140 and implementing backscatter communication. After obtaining power, the zero-power device 140 may receive a control signaling from the network device 120, and transmit data to the network device 120 by means of backscattering based on the control signaling. The transmitted data may come from data stored by the zero-power device 140 itself (e.g., identity identification or pre-written information, such as product manufacturing date, brand, and, manufacturer).

The zero-power device 140 may also include a sensor module 144 and a memory 145. The sensor module 144 may include various types of sensors, and the zero-power device 140 may report data collected by various types of sensors based on the zero-power mechanism. The memory 145 is used to store some basic information (such as article identification) or to store acquired sensing data such as ambient temperature and ambient humidity.

The zero-power device 140 does not need a battery, and may perform simple operations such as simple signal demodulation, decoding or encoding, and modulation via the low-power computing module 143. Therefore, the zero-power device 140 only needs a minimalist hardware design, which makes the zero-power device 140 low cost and small volume.

The network device 120 includes, but are not limited to, a cellular network device (such as 5G/6G network devices, base station devices), a WiFi/WLAN network device (such as an Access Point (AP), a router, a mobile access point—e.g., a mobile phone).

The zero-power device 140 includes, but is not limited to, a handheld device, a wearable device, a vehicle-mounted device, an Internet of Things device, and the like. The zero-power device 140 may be at least one of: a mobile phone, a tablet computer, an electronic book reader, a laptop computer, a desktop computer, a television, a game machine, an Augmented Reality (AR) terminal, a Virtual Reality (VR) terminal, a Mixed Reality (MR) terminal, a wearable device, a handle, an electronic tag, or a controller, or the like.

### Next, Zero-Power Communication is Further Introduced

### Radio Frequency Power Harvesting

FIG. 2 illustrates a diagram of radio frequency power harvesting provided by an exemplary embodiment of the present disclosure. The radio frequency power harvesting is based on the principle of electromagnetic induction, where a RF module is used to perform electromagnetic induction and is connected to a capacitor C and a load resistor RL that are arranged in parallel, enabling harvesting of electromagnetic wave power in space, and obtaining the power required for driving the operation of the zero-power device, for example, driving a low-power demodulation module, modulation module, sensor and memory reading. Therefore, the zero-power device requires no traditional battery.

### Backscattering

FIG. 3 illustrates a diagram of a backscatter communication process provided by an exemplary embodiment of the present disclosure. The zero-power device 140 receives a radio signal carrier 131 transmitted by a Transmit (TX) module 121 of the network device 120 via an AMPlifier (AMP) 122, modulates the radio signal carrier 131, loads information to be transmitted via a logic processing module 147, and harvests radio frequency power via the power harvesting module 141. The zero-power device 140 radiates a modulated reflected signal 132 via an antenna 146. This information transmission process is referred to as backscatter communication. A Receive (RX) module 123 of the network device 120 receives the modulated reflected signal 132 via a Low Noise Amplifier (LNA) 124. Backscattering and load modulation functions are inseparable. In the load modulation, circuit parameters of an oscillation loop in the zero-power device 140 are adjusted and controlled according to the beat of a data stream, so that parameters such as the impedance magnitude of an electronic tag are changed accordingly, thus completing modulation.

Load modulation technology mainly includes resistive load modulation and capacitive load modulation. FIG. 4 illustrates a diagram of resistive load modulation provided by an exemplary embodiment of the present disclosure. In the resistive load modulation, a load resistor R_{L} is connected in parallel with a third resistor R₃, and is switched on or off based on a switch S controlled by binary code. The on/off of the third resistor R₃ causes a change in a voltage in the circuit, the load resistor R_{L} is connected in parallel with a first capacitor C₁, the load resistor R_{L} is connected in series with a second resistor R₂, and the second resistor R₂ is connected in series with a first inductor L₁. The first inductor L₁ is coupled with a second inductor L₂, and the second inductor L₂ and a second capacitor C₂ are connected in series. Thus, Amplitude Shift Keying (ASK) modulation can be realized, that is, signal modulation and transmission are realized by adjusting the amplitude of the backscattered signal of the zero-power device, Similarly, in the capacitive load modulation, the resonant frequency of the circuit can be changed by on/off of the capacitor, thereby realizing Frequency Shift Keying (FSK) modulation, that is, signal modulation and transmission are realized by adjusting the operating frequency of the backscattered signal of the zero-power device.

The zero-power device modulates information of an incoming signal by means of load modulation, thereby realizing a backscatter communication process. The zero-power device has significant advantages: (1) the zero-power device does not actively transmit a signal, and thus no complex radio frequency link (such as a Power Amplifier (PA), a radio frequency filter) is required; (2) the zero-power device does not need to actively generate a high-frequency signal, and thus no high-frequency crystal oscillator is required; (3) with the help of backscatter communication, signal transmission of the zero-power device does not need to consume power of the zero-power device itself.

### Ultra-Low-Power Active Transmission Technology

The zero-power device can also use ultra-low-power active transmission techniques. Different from backscattering, when the zero-power device uses ultra-low-power active transmission technology for data transmission, the zero-power device needs to use a relatively simple and low-power oscillator to generate a radio frequency carrier, and then modulate the information to be transmitted onto the radio frequency carrier. Based on the current research, the power consumption of ultra-low-power active transmitters can be as low as hundreds of microwatts, so ultra-low power data transmission can be achieved.

### Encoding Manners for Zero-Power Communication

FIG. 5 is a diagram of encoding manners provided by an exemplary embodiment of the present disclosure. The data transmitted by the electronic tag can be represented as binary “1” and “0” in different forms of codes. A radio frequency identification system typically uses one of the following encoding manners: Not Return to Zero (NRZ) encoding, Manchester encoding, Unipolar Return to Zero (URZ) encoding, Differential Binary Phase (DBP) encoding, Miller encoding, or differential encoding. That is, different pulse signals can be used to represent 0 and 1.

(1) NRZ encoding: in NRZ encoding, binary “1” is represented by a high level, and binary “0” is represented by a low level. The NRZ encoding in FIG. 5 is a level diagram illustrating encoding of binary data 101100101001011 using the NRZ manner.

(2) Manchester encoding: Manchester encoding is also called Split-Phase Coding. In Manchester encoding, a binary value is represented by the change (rising or falling) of a level at half of a bit period within the bit length. A negative jump at half of the bit period represents binary “1”, and a positive jump at half of the bit period represents binary “0”. The error of data transmission refers to the fact that when the data bits transmitted by multiple electronic tags simultaneously have different values, the received rising and falling edges cancel each other out, resulting in an uninterrupted carrier signal throughout the bit length. Manchester encoding ensures that no state without change can exist within the bit length. The reader/writer can use this error to determine the specific location of the collision. Manchester encoding is beneficial to finding errors in data transmission. When load modulation or backscatter modulation of carrier is used, it is usually used for data transmission from electronic tags to readers and writers. The Manchester encoding in FIG. 5 is a level diagram illustrating encoding of binary data 101100101001011 using the Manchester manner.

(3) URZ encoding: in URZ encoding, binary “1” is represented by a high level in the first half of a bit period, while binary “0” is represented by a low level signal lasting for the whole bit period. The URZ encoding in FIG. 5 is a level diagram illustrating encoding of binary data 101100101001011 using the URZ manner.

(4) DBP encoding: in DBP encoding, binary “0” is represented by any edge in half of a bit period, and binary “1” is represented where there is no edge. Furthermore, a level is inverted at the beginning of each bit period. Therefore, for the receiver, the bit beats are relatively easy to reconstruct. The DBP encoding in FIG. 5 is a level diagram illustrating encoding of binary data 101100101001011 using the DBP manner.

(5) Miller encoding: in Miller encoding, binary “1” is represented by any edge in half of a bit period, and binary “0” is represented by an unchanged level in a next bit period. The level alternation occurs at the beginning of the bit period, and the bit beats are relatively easy to reconstruct for the receiver. The Miller encoding in FIG. 5 is a level diagram illustrating encoding of binary data 101100101001011 using the Miller manner.

(6) Differential encoding: in differential encoding, each binary “1” to be transmitted will cause a change in the level of a signal, while the level of the signal keeps unchanged for a binary “0”.

### Classification of Zero-Power Devices

The zero-power devices may be divided into passive zero-power devices, semi-passive zero-power devices, and active zero-power devices based on the power source and the usage of the zero-power devices.

### (1) Passive Zero-Power Device

The zero-power device does not require a built-in battery. When the zero-power device is close to the network device, the zero-power device is in a near-field range formed by antenna radiation of the network device. For example, the network device is a reader/writer of a Radio Frequency Identification (RFID) system. Therefore, an antenna of the zero-power device generates an induced current through electromagnetic induction, and the induced current drives the low-power chip circuit of the zero-power device, so as to realize signal demodulation for a forward link and signal modulation for a backward link. For a backscattering link, the zero-power device may perform signal transmission by means of backscattering or ultra-low-power active transmission. The passive zero-power device does not need to be driven by a built-in battery no matter for the forward link or the backward link, and is truly a zero-power device. The passive zero-power device requires no battery, and the RF circuit and baseband circuit are very simple, such as not requiring devices such as LNA, PA, crystal oscillator, Analog to Digital Converter (ADC), so it has many advantages such as small size, light weight, cheap price and long service life.

(2) Semi-Passive Zero-Power Device

The semi-passive zero-power device is also not equipped with conventional batteries, but may harvest radio wave power using the RF power harvesting module and store the harvested power in a power storage unit (such as capacitor). After the power storage unit obtains power, it may drive the low-power chip circuit of the zero-power device, to realize operations such as signal demodulation for a forward link and signal modulation for a backward link. For a backscattering link, the zero-power device may perform signal transmission by means of backscattering or ultra-low-power active transmission.

The semi-passive zero-power device does not need to be driven by a built-in battery no matter for the forward link or the backward link, where the power stored by the capacitor used in the operation comes from the radio power harvested by the RF power harvesting module, and thus is truly a zero-power device. The semi-passive zero-power device inherits many advantages of the passive zero-power device, so it has many advantages such as small size, light weight, cheap price and long service life.

(3) Active Zero-Power Device

The zero-power device used in some scenarios may also be the active zero-power device. Such zero-power device can have built-in batteries. The batteries are used to drive a low-power chip circuit of the zero-power device, to realize operations such as signal demodulation for a forward link and signal modulation for a backward link. However, for a backscattering link, the zero-power device may perform signal transmission by means of backscattering or ultra-low-power active transmission. Therefore, the “zero power” of the active zero-power device mainly lies in that the signal transmission on the backward link does not require power of the zero-power device itself, but uses backscattering. In the active zero-power device, the built-in battery supplies power to the RFID chip, increasing the reading/writing distance of the tag and improving the reliability of communication. Therefore, it can be applied in some scenarios that have high requirements in aspects such as communication distance and reading delay.

### Classification of Zero-Power Devices Based on Transmitter Type

### (1) Backscattering-Based Zero-Power Device

Such zero-power devices performs uplink data transmission through backscattering as described above. Such zero-power devices have no active transmitter that performs active transmission, but only have a backscattering transmitter. Therefore, when transmitting uplink data, such zero-power terminals need the network device to provide carriers, and such zero-power terminal devices perform backscattering based on the carriers, to realize uplink data transmission.

### (2) Active Transmitter-Based Zero-Power Device

Such zero-power devices use an active transmitter with active transmission capability to perform uplink data transmission. Therefore, when transmitting uplink data, such zero-power devices can transmit uplink data by using their own active transmitters without need of carriers provided by the network device. Active transmitters suitable for zero-power devices may be, for example, ultra-low power ASK transmitters, or ultra-low power FSK transmitters. Based on current implementations, the overall power consumption of such transmitters can be reduced to 400 to 600 microwatts when transmitting a signal of 100 microwatt.

### (3) Zero-Power Device Having Both Backscattering and Active Transmitter

Such zero-power devices can support not only backscattering, but can also support active transmitters. The zero-power devices can determine, according to different situations (such as the battery level, and available environmental energy) or based on the scheduling of the network device, whether to use the backscattering or to use the active transmitter to perform active transmission.

### Application Scenarios of Zero-Power Communication

Due to its significant advantages such as extremely low cost, zero power consumption, and small size, zero-power communication can be widely used in various industries, including vertical-industry applications such as logistics, smart warehousing, smart agriculture, energy and power, industrial Internet. It can also be applied to personal applications such as smart wearable and smart home systems.

### Cellular Internet of Things

The cellular Internet of Things is booming. For example, the 3rd Generation Partnership Project (3GPP) has standardized Narrow Band-Internet of Things (NB-IoT), Machine-Type Communications (MTC), Reduced Capability (RedCap) and other IoT technologies. However, there are still many scenarios where the IoT communication needs cannot be met.

The scenarios include for example a harsh communication environment. Some IoT scenarios may face extreme environments such as a high temperature, an extremely low temperature, high humidity, a high pressure, high radiation or high-speed movement. Examples include an ultra-high voltage transformer substation, monitoring of the tracks of a high-speed train, environmental monitoring in alpine zones, and an industrial production line. In these scenarios, the existing IoT terminal devices would be unable to work due to limitation to the working environment of conventional power supplies. In addition, extreme working environments are disadvantageous to maintenance of the IoT terminal devices, such as battery replacement.

The scenarios include for another example a requirement in the terminal form of an extremely small size. Some IoT communication scenarios, such as food traceability, commodity circulation, and smart wearables, require the terminals to have extremely small sizes to facilitate use in these scenarios. For example, IoT terminal devices used for commodity management in the circulation link are usually in the form of electronic tags and are embedded into commodity packaging in a very compact form. For another example, light weighted wearable IoT terminal devices can improve user experience while meeting user needs.

The scenarios include for another example a requirement in the IoT communication of an extremely low cost. Numerous IoT communication scenarios require the cost of IoT terminal devices to be low enough to improve competitiveness relative to other alternative technologies. For example, in logistics or warehousing scenarios, in order to facilitate the management of a large number of circulating items, an IoT terminal device may be attached to each item, so as to complete the accurate management of the entire logistics process and cycle through the communication between the IoT terminal device and the logistics network. These scenarios require the price of IoT terminal devices to be competitive enough.

Therefore, in order to cover these unmet IoT communication needs, the cellular IoT also needs to develop ultra-low-cost, extremely small-size, battery-free/maintenance-free IoT, and the zero-power IoT can just meet these needs.

The zero-power IoT, also known as Ambient IoT (A-IoT), or passive Internet of Things (passive IoT). Ambient IoT devices refer to IoT devices that use various environmental energy (such as RF energy, light energy, solar energy, thermal energy, mechanical energy) to drive themselves. Such devices may have no energy storage capacity or have very limited energy storage capacity (such as using capacitors with a capacity of tens of microfarads). Compared with other IoT devices, Ambient IoT devices have many advantages such as conventional battery-free, maintenance-free, small size, low complexity, low cost, and long life cycle.

The zero-power IoT may be used in at least the following four types of scenarios.
(1) Object recognition, such as logistics, management of products in a production line, and supply chain management.
(2) Environmental monitoring, such as monitoring of temperatures, humidity and harmful gas in working environment and natural environment.
(3) Positioning, such as indoor positioning, intelligent object search, and item positioning in a production line.
(4) Intelligent control, such as intelligent control of various electrical appliances in smart homes (turning on/off of an air conditioner, temperature adjustment), and intelligent control of various facilities in agricultural greenhouses (automatic watering, and fertilization).

### Introduction of Scheduling of Data Transmission

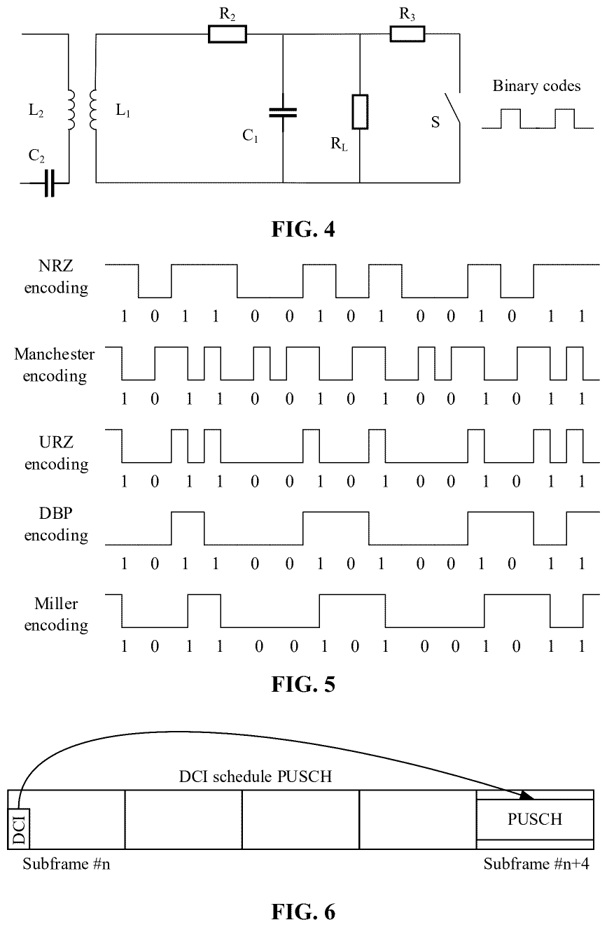

In a cellular system, uplink transmission of a mobile terminal (such as a mobile phone) is usually controlled by scheduling of a base station. For example, information including uplink (UL) time-frequency resource, Modulation and Coding Scheme (MCS), Hybrid Automatic Repeat reQuest (HARQ) process, Redundancy Version (RV) and the like are indicated through a Downlink Control Information (DCI) format 0. FIG. 6 illustrates a diagram of uplink transmission scheduling in an LTE system provided by an exemplary embodiment of the present disclosure. As illustrated in FIG. 6, the base station transmits a DCI in a subframe #n, scheduling a user to perform uplink data transmission in a subframe #n+4, with an interval of four subframes between the subframe #n and the subframe #n+4 for the user to prepare uplink data. In an NR system, an interval k between the DCI and the Physical Uplink Shared Channel (PUSCH) is more flexible, and the value of k is dynamically indicated through the DCI, such as 1 to 3 slots. A similar relationship exists between the Physical Downlink Shared Channel (PDSCH) and the scheduling DCI.

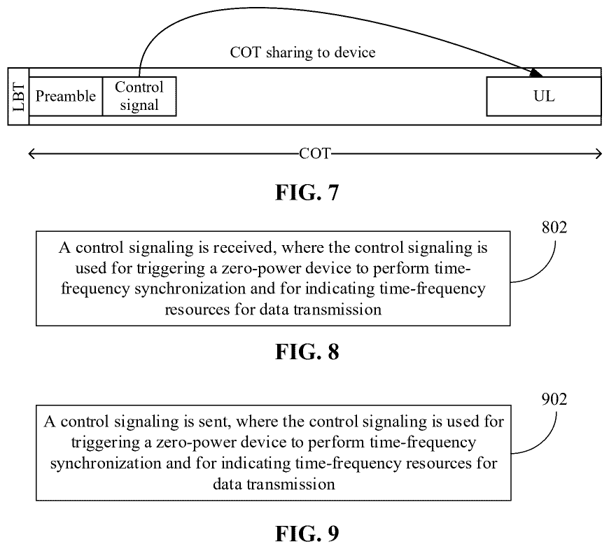

FIG. 7 illustrates a diagram of transmission scheduling in a WLAN system provided by an exemplary embodiment of the present disclosure. As illustrated in FIG. 7, in the WLAN system, a network device (AP) can perform channel listening via Listen Before Talk (LBT) and obtain transmission rights for a period of time. Considering the power consumption of A-IoT devices, one way is that after acquiring a channel, the AP allocates the channel to an A-IoT device. For example, the AP detects that the channel is idle via LBT, and transmits a preamble signal to occupy a Channel Occupation Time (COT) of 8 ms. The AP may allocate the last 2 ms within the COT to a certain A-IoT device for its uplink transmission, through a control signal.

Based on the above introduction, it can be seen that RF and baseband circuits of zero-power devices are very simple, so the zero-power devices have many advantages such as small size, light weight, low cost, long service life, and maintenance-free. However, such a design also brings many technical challenges. For example, in order to achieve low complexity of the zero-power devices and thereby save power consumption of the zero-power devices, crystal oscillators configured for the zero-power devices are usually relatively simple, such as passive 32k crystal oscillators. It takes a certain amount of time for a crystal oscillator in a zero-power device to complete the time-frequency synchronization procedure. Depending on factors such as the frequency of the crystal oscillator, load capacitance and required synchronization accuracy, the duration of the synchronization procedure of the zero-power devices may range from a few milliseconds to hundreds of milliseconds. Therefore, it is necessary to redesign scheduling/control signaling related to the zero-power devices, such as scheduling the time-domain location for data transmission of the zero-power devices, so as to ensure that sufficient time is reserved for the zero-power devices to complete time-frequency synchronization while avoiding a long waiting delay for data transmission.

According to the methods provided by the present disclosure, a two-step control signaling is used for scheduling a time-frequency synchronization procedure and data transmission of a zero-power device. Herein, the first-step control signaling (a first control signaling) is used for triggering the zero-power device to perform time-frequency synchronization, while the second-step control signaling (a second control signaling) is used for scheduling the zero-power device to perform data transmission (sending/receiving), and the second-step control signaling can schedule a time domain resource position for the data transmission. Alternatively, a single-step control signaling (a third control signaling) is used for simultaneously triggering the zero-power device to perform time-frequency synchronization and scheduling data transmission of the zero-power device. By scheduling the time-frequency synchronization and data transmission of the zero-power device through the control signaling, it can be ensured that sufficient time is reserved for the zero-power device to perform the time-frequency synchronization before the data transmission, and a long waiting delay for data transmission is avoided, thereby helping to ensure the time-frequency accuracy (or the time-frequency precision) of the zero-power device and improving the reliability of data transmission and/or reception of the zero-power device.

FIG. 8 is a flowchart of a data transmission method provided by an exemplary embodiment of the present disclosure. The method may be performed by a zero-power device. The method includes an operation 802.

The operation 802: a control signaling is received, here, the control signaling is used for triggering the zero-power device to perform time-frequency synchronization and indicating time-frequency resources for data transmission.

The control signaling may also be referred to as or replaced with control information, indication information, indication signaling, scheduling information, or a scheduling signaling. The specific terminology used for the control signaling is not limited in the embodiments of the present disclosure. In some embodiments, the control signaling is used for simultaneously triggering the zero-power device to perform the time-frequency synchronization and indicating the time-frequency resources for the data transmission of the zero-power device. In some embodiments, the control signaling is used for separately triggering the zero-power device to perform the time-frequency synchronization and indicating the time-frequency resources for the data transmission of the zero-power device. The time-frequency synchronization includes at least one of time synchronization or frequency synchronization. The time-frequency resources include at least one of a time-domain resource or a frequency-domain resource. The above “triggering” may also be referred to as or replaced with “waking up” or “activating”.

The data transmission of the zero-power device includes at least one of data receiving or data sending. In some embodiments, “data sending” includes “sending in uplink” (i.e., transmit via an uplink), for example, the zero-power device sends/transmits data to a network device (base station, AP, etc.). Moreover, “data sending” may further include “sending in sidelink” (i.e., transmit via a sidelink), for example, the zero-power device sends/transmits data to another user equipment (mobile phone, computer, another zero-power device, etc.) via a sidelink. In some embodiments, “data receiving” includes “receiving downlink data” (i.e., receive via a downlink), for example, receiving data transmitted by the network device (base station, AP, etc.). Moreover, “data receiving” may further include “sidelink reception” (i.e., receive via a sidelink), for example, receiving data transmitted by another user equipment (mobile phone, computer, another zero-power device, etc.) via a sidelink. For ease of description, sending/transmitting data from the zero-power device to an AP, base station or another device may be referred to as uplink transmission, while sending/transmitting data from the AP, base station, or another device to the zero-power device may be referred to as downlink transmission.

In some embodiments, the control signaling is sent by the network device to the zero-power device. After receiving the control signaling, the zero-power device performs the time-frequency synchronization based on indication of the control signaling, and performs the data transmission based on the time-frequency resources indicated by the control signaling.

### For the Case Where the Control Signaling is 2-Step Controlling Signaling

The control signaling includes a first control signaling (the first-step control signaling, control 1) and a second control signaling (the second-step control signaling, control 2). The first control signaling is used for triggering the zero-power device to perform the time-frequency synchronization, and the second control signaling is used for indicating the time-frequency resources for the data transmission of the zero-power device.

In some embodiments, the second control signaling is after the first control signaling or the first control signaling is before the second control signaling. This sequential order includes a sequential relationship in a time domain.

In some embodiments, the first control signaling includes at least one of: a trigger signal, information related to the time-frequency synchronization, device information of a target device, or information related to the second control signaling.

Here, the trigger signal is also referred to as or may be replaced with a wake-up signal. In some embodiments, the trigger signal is used for triggering (waking up) the zero-power device to activate its crystal oscillator for a time-frequency synchronization procedure, to enable subsequent data transmission. The target device includes a device that performs the data transmission with the zero-power device. In some embodiments, the device information of the target device includes at least one of device identification information or device group identification information.

In some embodiments, the information related to the time-frequency synchronization includes at least one of: an accuracy requirement for the time-frequency synchronization, a synchronization time for the time-frequency synchronization, a modulation manner for the data transmission, or a type of a synchronization signal.

In some embodiments, the accuracy requirement for the time-frequency synchronization is used by the zero-power device to estimate/determine the synchronization time (synchronization duration) required for the time-frequency synchronization, for example, 10 ppm, 50 ppm, 100 ppm, 300 ppm. In some embodiments, the synchronization time required for the time-frequency synchronization is positively correlated with the accuracy of the time-frequency synchronization.

In some embodiments, the modulation manner for the data transmission is used by the zero-power device to estimate/determine the synchronization time required for the time-frequency synchronization. For example, for On-Off Keying (OOK) modulation and Phase Shift Keying (PSK) modulation, their capabilities to resist frequency offset differ. The OOK modulation is more susceptible to frequency offset, thus requiring higher-accuracy time-frequency synchronization prior to the data transmission. In other words, the zero-power device requires the longer synchronization time in this case.

In some embodiments, the synchronization signal includes signal(s) used by the zero-power device for the time-frequency synchronization. In some embodiments, the type of the synchronization signal includes at least one of: a type of a sequence used for the synchronization signal, a waveform of the synchronization signal, a frequency-domain position of the synchronization signal, a period of the synchronization signal, or a duty cycle of the synchronization signal. In some embodiments, the type of the synchronization signal is used by the zero-power device to estimate/determine the synchronization time required for the time-frequency synchronization. The synchronization signal may directly follow the synchronization signal from the related technologies or may be a newly redesigned synchronization signal. In some embodiments, in a WLAN system, the synchronization signal may be the same as or different from a Wake Up Radio (WUR) Synchronization (Sync) signal.

In some embodiments, based on the modulation manner and/or other information (e.g., the above accuracy requirement, the synchronization signal) for the data transmission, the zero-power device may determine an approximate time required for the time-frequency synchronization.

In some embodiments, a unit of the synchronization time includes at least one of: a radio frame (or referred to as a frame), a subframe, a slot, a symbol, or a millisecond (ms). In some embodiments, because the zero-power device will also receive the second control signaling at a time point for scheduling data transmission, the synchronization time for the zero-power device to perform the time-frequency synchronization is less than (slightly less than) a time-domain gap from the first control signaling to the data transmission. After determining the synchronization time for the time-frequency synchronization, the zero-power device may infer an approximate time point of the second control signaling.

In some embodiments, the information related to the time-frequency synchronization is indicated by a field carried in the first control signaling from multiple candidate values, or is indicated by a generation sequence used by the first control signaling from multiple candidate values. In some embodiments, the multiple candidate values are preset, or pre-configured, or configured by a higher-layer signaling. For example, regarding the accuracy requirement for the time-frequency synchronization, N candidate values are preset in a protocol, and the accuracy requirement for the time-frequency synchronization is indicated by a log₂(N)-bit field in the first control signaling based on one-to-one correspondences between values of the field and the N candidate values, where N is a positive integer greater than 1. For example, the candidate values of the accuracy requirement for the time-frequency synchronization are [10 ppm, 50 ppm, 100 ppm, 300 ppm] respectively corresponding to four values of the field [00, 01, 10, 11]. When generating the sequence used for the first control signaling, multiple sequences may be generated, where each sequence indicates a candidate value from the multiple candidate values, thereby indicating the above information related to the time-frequency synchronization.

In some embodiments, the information related to the second control signaling includes at least one of: a time-domain gap between the first control signaling and the second control signaling, a monitoring time window for the second control signaling, time-frequency resources for the second control signaling, or a modulation manner for the second control signaling.

In some embodiments, the modulation manner includes a modulation manner in Modulation and Coding Scheme (MCS).

Considering the uncertainty of resource scheduling and LBT, the network device may not be able to accurately predict the time-domain resources for the second control signaling when transmitting the first control signaling. However, the network device can provide an approximate time window (the monitoring time window) to facilitate monitoring by the zero-power device. To facilitate monitoring by the zero-power device, the first control signaling is typically designed to be as simple as possible, with minimal payload and occupying a much smaller bandwidth. In contrast, the payload, modulation and coding scheme, etc., of the second control signaling may be significantly more complex than those of the first control signaling.

In some embodiments, after receiving the first control signaling, the zero-power device begins receiving the synchronization signal to perform the time-frequency synchronization. For example, it may receive the synchronization signal more frequently according to a shorter period, or wake up the Main Radio (MR) to perform the synchronization procedure.

The second control signaling is used for indicating the specific time-frequency resources for the data transmission of the zero-power device.

In some embodiments, for unlicensed spectrum, the network device can determine the resources allocated to the zero-power device only after successfully obtaining a channel through LBT. Additionally, the COT obtained by the network device in each LBT is relatively limited. If the time required for the synchronization procedure is too long, it may actually exceed the duration of the COT even if it has already been allocated via the first control signaling. Therefore, when the synchronization procedure requires the longer time, regardless of whether the 2-step control signaling is used, the network device needs to perform LBT again to obtain a channel, so as to determine the resources allocated for the data transmission of the zero-power device. For licensed spectrum, the network device and the zero-power device can use a channel without channel listening, making the advantages of using the 2-step control signaling potentially less significant compared to unlicensed spectrum.

In some embodiments, a time-domain gap K between the first control signaling and the data transmission of the zero-power device (or the synchronization time T for the time-frequency synchronization, or a time-domain gap between the first control signaling and the second control signaling) is controlled by the network device (e.g., AP) sending the control signaling. The network device may determine the time-domain gap based on the following factors.

The factors may include a data type for the data transmission, a modulation manner for the data transmission, and/or the like. For example, if the transmitted data is significantly affected by frequency offset, the network device will reserve the longer time K for the zero-power device to perform the time-frequency synchronization, thereby obtaining higher synchronization accuracy. Conversely, the network device will reserve the shorter time K to reduce the transmission delay of the data transmission.

The factors may include a capability of the zero-power device. Since the zero-power device with stronger capabilities can complete synchronization more quickly, the network device may reserve the shorter time K. Conversely, the network device will reserve the longer time K. The synchronization capability of the zero-power device is reported by the zero-power device to the network device, such as an AP or base station.

The factors may include characteristics of the synchronization signal, for example, the length, period, transmission duty cycle, waveform, and/or modulation manner of the synchronization signal.

In some embodiments, the time-domain gap K reserved by the network device is greater than or equal to the actually required synchronization time determined by the zero-power device based on the first control signaling. For example, the zero-power device determines, based on the first control signaling in slot #n, that the indicated synchronization time T=10 slots. The network device may select K=12, i.e., send the second control signaling in slot #n+12. The zero-power device performs the time-frequency synchronization within the 10 slots from slot #n+1 to slot #n+10, and starts monitoring for the second control signaling in slot #n+11. In some embodiments, the zero-power device also performs time-frequency synchronization after the time-domain gap, for example in slot #n+11, to maintain synchronization accuracy.

In some embodiments, at least one of the first control signaling or the second control signaling further includes at least one of: data content for the data transmission, a data type for the data transmission, or a modulation manner for the data transmission.

In some embodiments, if the same information is indicated in both the first control signaling and the second control signaling, the first control signaling and the second control signaling may be allowed to indicate different values for that same information. The zero-power device uses the value indicated by the second control signaling for the data transmission.

In some embodiments, the synchronization signal (e.g., a beacon frame) can be provided by different devices or on different frequency points. This approach enables the zero-power device to, in most cases, only need to monitor the first control signaling and a part of downlink signals. The zero-power device is triggered to perform the time-frequency synchronization only when the data transmission is required. Furthermore, in the 2-step control signaling, the first control signaling and the signaling overhead thereof can be made as simple as possible, thereby reducing the complexity and power consumption for the zero-power device to monitor and detect the first control signaling.

### For the Case Where the Control Signaling is Single-Step Controlling Signaling

The control signaling includes a third control signaling (the single-step control signaling). The third control signaling is used for simultaneously triggering the zero-power device to perform the time-frequency synchronization and indicating the time-frequency resources for the data transmission of the zero-power device.

In some embodiments, the third control signaling includes a first field and a second field. The first field is used for indicating information related to the time-frequency synchronization, and the second field is used for indicating the time-frequency resources for the data transmission. For the contents and indication methods of the information related to the time-frequency synchronization, the reference may be made to the foregoing relevant contents, which will not be repeated in the embodiments of the present disclosure.

In some embodiments, the third control signaling includes a second field. The second field is used for indicating (explicitly indicating) the time-frequency resources for the data transmission. In this case, the third control signaling is used for implicitly triggering the zero-power device to perform the time-frequency synchronization, and further triggering the zero-power device to determine the synchronization time for the time-frequency synchronization. In some embodiments, after receiving the third control signaling, the zero-power device will automatically trigger the execution of the time-frequency synchronization procedure until the indicated time for the data transmission.

In some embodiments, since a time-domain position for the data transmission is known (indicated by the third control signaling), the zero-power device can autonomously perform the time-frequency synchronization before the data transmission based on implementation of the zero-power device. For example, if the third control signaling in slot #n indicates that the data transmission is to be performed in slot #n+12, the zero-power device can perform the time-frequency synchronization within the time period from slot #n to slot #n+12. Assuming the zero-power device determines that six slots are sufficient to complete the time-frequency synchronization, it may choose to perform the time-frequency synchronization in six slots from slot #n to slot #n+5 or from slot #n+6 to slot #n+11, or in any six slots (consecutive or non-consecutive) within the time period from slot #n to slot #n+12.

In some embodiments, for unlicensed spectrum, before the data transmission, the zero-power device needs to first obtain a channel via UL LBT, or the network device obtains a channel via DL LBT and shares COT resources to the zero-power device.

In some embodiments, the time-frequency resources for the data transmission indicated by the third control signaling include a time-domain position for the data transmission. In some embodiments, the time-frequency resources for the data transmission indicated by the third control signaling include a time-domain gap between the data transmission and the third control signaling. For example, it is a slot (i.e., slot #n+K) that is K slots apart from slot #n where the third control signaling is located.

In some embodiments, a unit of the time-domain gap includes at least one of a radio frame, a subframe, a slot, a symbol, or a millisecond.

Considering that the time-domain gap required for the time-frequency synchronization, which is influenced by factors such as the capability of the zero-power device and the required synchronization accuracy, ranges from several milliseconds to several hundred milliseconds, if the time-domain gap is directly indicated in the third control signaling, this results in larger signaling overhead, for example, the value of K varies within a range of [1, 200] ms, thus a total of ceil(log₂(200))=8 bits is required. To reduce the signaling overhead of the third control signaling, one or any combination of the following manners may be adopted.

In some embodiments, the time-domain gap is indicated by a product of a first indication value carried in the third control signaling and a time granularity. For example, Ka is the first indication value, the time granularity s=10 ms. If the range of the time-domain gap K is [1, 200] ms and a range of Ka is [1, 2, 3, . . . , 19, 20] ms, then indication of K in the third control signaling needs a total of ceil(log₂(200/s))=5 bits. s=10 ms corresponds to a duration of one radio frame, and the specific slot in the radio frame corresponding to the data transmission may be determined based on the following manners: (1) based on the slot where the third control signaling is located, e.g., the third control signaling is in slot #i of radio frame #n, and Ka indicated by the third control signaling equals to 7, thus the time-domain position for the data transmission is in slot #i of radio frame #n+7; (2) based on a result of LBT, where based on Ka indicated by the third control signaling, the zero-power device can determine to perform the data transmission within radio frame #n+Ka; and then the zero=power device performs LBT one or more times within this radio frame, and determines the slot for the data transmission among slots after a successful LBT.

In some embodiments, the time-domain gap is indicated by a sum of a second indication value carried in the third control signaling and an offset value. For example, the second indication value is Kb and the fixed offset value is Δoffset, thus the time-domain gap K=Kb+Δoffset. For example, Δoffset is fixed to be 100 ms and Kb=[1, 2, 3, 4] ms, thus the range of K is [101, 102, 103, 104] ms.

In some embodiments, the time-domain gap is indicated by a sum of a product and an offset value, where the product is a product of a first indication value carried in the third control signaling and a time granularity. For example, Ka is the first indication value, the fixed offset value is Δoffset, and the time granularity is s, thus the time-domain gap K=Ka*s+Δoffset. If Δoffset is fixed to be 100 ms, s=10 ms, and Ka=[1, 2, 3, 4] ms, then the range of K is [110, 120, 130, 140] ms.

In some embodiments, the time-domain gap is indicated by a third indication value carried in the third control signaling from a candidate value set. For example, the candidate value set is configured in a manner of pre-configuration or higher-layer signaling configuration. The third indication value is Ki, and the time-domain gap K may be indicated by Ki from the candidate value set. If the candidate value set Kset=[40, 50, 60, 70] ms and Ki=2, then it indicates that the second element in Kset is selected, i.e., K=50 ms.

In some embodiments, the time granularity, the offset value and the candidate value set are preset, or pre-configured, or configured by a higher-layer signaling. In some embodiments, the higher-layer signaling includes at least one of: a Radio Resource Control (RRC) message, or a Media Access Control Control Element (MAC CE).

In some embodiments, the time granularity, the offset value and the candidate value set are fixed values. In some embodiments, multiple sets of candidate items exist, and the candidate items include at least one of: the time granularity, the offset value, or the candidate value set. That is, for one or more of the time granularity, the offset value, or the candidate value set, there are multiple sets of values. The candidate item(s) used for determining the time-domain gap are determined based on at least one of: a capability of the zero-power device; data content for the data transmission; a data type for the data transmission; a modulation manner for the data transmission; a type of a synchronization signal; or an indication of a higher layer signaling.

For example, the candidate value set Kset has two sets of values, which are Kset1=[40, 50, 60, 70] ms and Kset2=[140, 150, 160, 170] ms, respectively. The zero-power device determines whether to use Kset1 or Kset2 based on the capability of the zero-power device (crystal oscillator device, time-frequency synchronization capability), where one zero-power device only corresponds to one of these Ksets. Alternatively, the zero-power device determines whether to use Kset1 or Kset2 based on the type, the modulation manner and/or the like of the transmitted data. For example, the third control signaling may indicate the type, the modulation manner and/or the like of data to be transmitted by the zero-power device, based on these information, the time-frequency synchronization accuracy required for the data transmission may be determined, thereby implicitly indicating a Kset. When high time-frequency synchronization accuracy is required, Kset2 is used to obtain higher accuracy through a longer time; otherwise, Kset1 is used. Alternatively, the zero-power device determines whether to use Kset1 or Kset2 based on the type (characteristics) of the synchronization signal. Alternatively, the zero-power device determines whether to use Kset1 or Kset2 based on an indication of a higher-layer signaling including a RRC message or a MAC CE.

In some embodiments, for the specific implementations regarding the second control signaling indicating the time-frequency resources for the data transmission, the reference may be made to the relevant description of the above third control signaling, which will not be repeated in the embodiments of the present disclosure.

In summary, according to the method provided in this embodiment, by using the control signaling to schedule the time-frequency synchronization and data transmission of the zero-power device, this can ensure that sufficient time is reserved for the zero-power device to perform time-frequency synchronization prior to the data transmission, and a long waiting delay for data transmission is avoided, thereby helping to ensure the time-frequency accuracy of the zero-power device and improving the reliability of data transmission and/or reception of the zero-power device.

FIG. 9 is a flowchart of a data transmission method provided by an exemplary embodiment of the present disclosure. The method may be performed by a network device, The method includes an operation 902.

The operation 902: a control signaling is sent, here, the control signaling is used for triggering a zero-power device to perform time-frequency synchronization and indicating time-frequency resources for data transmission.

In some embodiments, the control signaling is used for simultaneously triggering the zero-power device to perform the time-frequency synchronization and indicating the time-frequency resources for the data transmission of the zero-power device. In some embodiments, the control signaling is used for separately triggering the zero-power device to perform the time-frequency synchronization and indicating the time-frequency resources for the data transmission of the zero-power device. The time-frequency synchronization includes at least one of time synchronization or frequency synchronization. The time-frequency resources include at least one of a time-domain resource or a frequency-domain resource.

The data transmission of the zero-power device includes at least one of data receiving or data sending. In some embodiments, “data sending” includes “sending in uplink” (i.e., transmit via an uplink), for example, the zero-power device sends/transmits data to the network device (base station, AP, etc.). Moreover, “data sending” may further include “sending in sidelink” (i.e., transmit via a sidelink), for example, the zero-power device sends/transmits data to another user equipment (mobile phone, computer, another zero-power device, etc.) via a sidelink. In some embodiments, “data receiving” includes “receiving downlink data” (i.e., receive via a downlink), for example, receiving data transmitted by the network device (base station, AP, etc.). Moreover, “data receiving” may further include “sidelink reception” (i.e., receive via a sidelink), for example, receiving data transmitted by another user equipment (mobile phone, computer, another zero-power device, etc.) via a sidelink.

In some embodiments, after receiving the control signaling, the zero-power device performs the time-frequency synchronization based on indication of the control signaling, and performs the data transmission based on the time-frequency resources indicated by the control signaling.

### For the Case Where the Control Signaling is 2-Step Controlling Signaling

The control signaling includes a first control signaling (the first-step control signaling, control 1) and a second control signaling (the second-step control signaling, control 2). The first control signaling is used for triggering the zero-power device to perform the time-frequency synchronization, and the second control signaling is used for indicating the time-frequency resources for the data transmission of the zero-power device.

In some embodiments, the second control signaling is after the first control signaling or the first control signaling is before the second control signaling. This sequential order includes a sequential relationship in a time domain.

In some embodiments, the first control signaling includes at least one of: a trigger signal, information related to the time-frequency synchronization, device information of a target device, or information related to the second control signaling.

In some embodiments, the trigger signal is used for triggering (waking up) the zero-power device to activate its crystal oscillator for a time-frequency synchronization procedure, to enable subsequent data transmission. The target device includes a device that performs the data transmission with the zero-power device. In some embodiments, the device information of the target device includes at least one of device identification information or device group identification information.

In some embodiments, the information related to the time-frequency synchronization includes at least one of: an accuracy requirement for the time-frequency synchronization, a synchronization time for the time-frequency synchronization, a modulation manner for the data transmission, or a type of a synchronization signal.

In some embodiments, the accuracy requirement for the time-frequency synchronization is used by the zero-power device to estimate/determine the synchronization time (synchronization duration) required for the time-frequency synchronization. In some embodiments, the synchronization time required for the time-frequency synchronization is positively correlated with the accuracy of the time-frequency synchronization.

In some embodiments, the modulation manner for the data transmission is used by the zero-power device to estimate/determine the synchronization time required for the time-frequency synchronization.

In some embodiments, the synchronization signal includes signal(s) used by the zero-power device for the time-frequency synchronization. In some embodiments, the type of the synchronization signal includes at least one of: a type of a sequence used for the synchronization signal, a waveform of the synchronization signal, a frequency-domain position of the synchronization signal, a period of the synchronization signal, or a duty cycle of the synchronization signal. In some embodiments, the type of the synchronization signal is used by the zero-power device to estimate/determine the synchronization time required for the time-frequency synchronization. The synchronization signal may directly follow the synchronization signal from the related technologies or may be a newly redesigned synchronization signal. In some embodiments, in a WLAN system, the synchronization signal may be the same as or different from a WUR Sync signal.

In some embodiments, based on the modulation manner and/or other information (e.g., the above accuracy requirement, the synchronization signal) for the data transmission, the zero-power device may determine an approximate time required for the time-frequency synchronization.

In some embodiments, a unit of the synchronization time includes at least one of: a radio frame (or referred to as a frame), a subframe, a slot, a symbol, or a millisecond (ms). In some embodiments, because the zero-power device will also receive the second control signaling at a time point for scheduling data transmission, the synchronization time for the zero-power device to perform the time-frequency synchronization is less than (slightly less than) a time-domain gap from the first control signaling to the data transmission. After determining the synchronization time for the time-frequency synchronization, the zero-power device may infer an approximate time point of the second control signaling.

In some embodiments, the information related to the time-frequency synchronization is indicated by a field carried in the first control signaling from multiple candidate values, or is indicated by a generation sequence used by the first control signaling from multiple candidate values. In some embodiments, the multiple candidate values are preset, or pre-configured, or configured by a higher-layer signaling.

In some embodiments, the information related to the second control signaling includes at least one of: a time-domain gap between the first control signaling and the second control signaling, a monitoring time window for the second control signaling, time-frequency resources for the second control signaling, or a modulation manner for the second control signaling.

In some embodiments, the modulation manner includes a modulation manner in MCS.

Considering the uncertainty of resource scheduling and LBT, the network device may not be able to accurately predict the time-domain resources for the second control signaling when transmitting the first control signaling. However, the network device can provide an approximate time window (the monitoring time window) to facilitate monitoring by the zero-power device. To facilitate monitoring by the zero-power device, the first control signaling is typically designed to be as simple as possible, with minimal payload and occupying a much smaller bandwidth. In contrast, the payload, modulation and coding scheme, etc., of the second control signaling may be significantly more complex than those of the first control signaling.

In some embodiments, after receiving the first control signaling, the zero-power device begins receiving the synchronization signal to perform the time-frequency synchronization. For example, it may receive the synchronization signal more frequently according to a shorter period, or wake up the MR to perform the synchronization procedure.

The second control signaling is used for indicating the specific time-frequency resources for the data transmission of the zero-power device.

In some embodiments, for unlicensed spectrum, the network device can determine the resources allocated to the zero-power device only after successfully obtaining a channel through LBT. Additionally, the COT obtained by the network device in each LBT is relatively limited. If the time required for the synchronization procedure is too long, it may actually exceed the duration of the COT even if it has already been allocated via the first control signaling. Therefore, when the synchronization procedure requires the longer time, regardless of whether the 2-step control signaling is used, the network device needs to perform LBT again to obtain a channel, so as to determine the resources allocated for the data transmission of the zero-power device. For licensed spectrum, the network device and the zero-power device can use a channel without channel listening, making the advantages of using the 2-step control signaling potentially less significant compared to unlicensed spectrum.

In some embodiments, a time-domain gap K between the first control signaling and the data transmission of the zero-power device (or the synchronization time T for the time-frequency synchronization, or a time-domain gap between the first control signaling and the second control signaling) is controlled by the network device (e.g., AP) sending the control signaling. The network device may determine the time-domain gap based on the following factors.

The factors may include a data type for the data transmission, a modulation manner for the data transmission, and/or the like.

The factors may include a capability of the zero-power device.

The factors may include characteristics of the synchronization signal, for example, the length, period, transmission duty cycle, waveform, and/or modulation manner of the synchronization signal.

In some embodiments, the time-domain gap K reserved by the network device is greater than or equal to the actually required synchronization time determined by the zero-power device based on the first control signaling.

In some embodiments, at least one of the first control signaling or the second control signaling further includes at least one of: data content for the data transmission, a data type for the data transmission, or a modulation manner for the data transmission.

In some embodiments, if the same information is indicated in both the first control signaling and the second control signaling, the first control signaling and the second control signaling may be allowed to indicate different values for that same information. The zero-power device uses the value indicated by the second control signaling for the data transmission.

In some embodiments, the synchronization signal (e.g., a beacon frame) can be provided by different devices or on different frequency points. This approach enables the zero-power device to, in most cases, only need to monitor the first control signaling and a part of downlink signals. The zero-power device is triggered to perform the time-frequency synchronization only when the data transmission is required. Furthermore, in the 2-step control signaling, the first control signaling and the signaling overhead thereof can be made as simple as possible, thereby reducing the complexity and power consumption for the zero-power device to monitor and detect the first control signaling.

### For the Case Where the Control Signaling is Single-Step Controlling Signaling

The control signaling includes a third control signaling (the single-step control signaling). The third control signaling is used for simultaneously triggering the zero-power device to perform the time-frequency synchronization and indicating the time-frequency resources for the data transmission of the zero-power device.

In some embodiments, the third control signaling includes a first field and a second field. The first field is used for indicating information related to the time-frequency synchronization, and the second field is used for indicating the time-frequency resources for the data transmission. For the contents and indication methods of the information related to the time-frequency synchronization, the reference may be made to the foregoing relevant contents, which will not be repeated in the embodiments of the present disclosure.

In some embodiments, the third control signaling includes a second field. The second field is used for indicating (explicitly indicating) the time-frequency resources for the data transmission. In this case, the third control signaling is used for implicitly triggering the zero-power device to perform the time-frequency synchronization, and further triggering the zero-power device to determine the synchronization time for the time-frequency synchronization. In some embodiments, after receiving the third control signaling, the zero-power device will automatically trigger the execution of the time-frequency synchronization procedure until the indicated time for the data transmission.

In some embodiments, since a time-domain position for the data transmission is known (indicated by the third control signaling), the zero-power device can autonomously perform the time-frequency synchronization before the data transmission based on implementation of the zero-power device.

In some embodiments, for unlicensed spectrum, before the data transmission, the zero-power device needs to first obtain a channel via UL LBT, or the network device obtains a channel via DL LBT and shares COT resources to the zero-power device.

In some embodiments, the time-frequency resources for the data transmission indicated by the third control signaling include a time-domain position for the data transmission. In some embodiments, the time-frequency resources for the data transmission indicated by the third control signaling include a time-domain gap between the data transmission and the third control signaling.

In some embodiments, a unit of the time-domain gap includes at least one of a radio frame, a subframe, a slot, a symbol, or a millisecond.

Considering that the time-domain gap required for the time-frequency synchronization, which is influenced by factors such as the capability of the zero-power device and the required synchronization accuracy, ranges from several milliseconds to several hundred milliseconds, if the time-domain gap is directly indicated in the third control signaling, this results in larger signaling overhead. To reduce the signaling overhead of the third control signaling, one or any combination of the following manners may be adopted.

In some embodiments, the time-domain gap is indicated by a product of a first indication value carried in the third control signaling and a time granularity.

In some embodiments, the time-domain gap is indicated by a sum of a second indication value carried in the third control signaling and an offset value.

In some embodiments, the time-domain gap is indicated by a sum of a product and an offset value, where the product is a product of a first indication value carried in the third control signaling and a time granularity.

In some embodiments, the time-domain gap is indicated by a third indication value carried in the third control signaling from a candidate value set.

In some embodiments, the time granularity, the offset value and the candidate value set are preset, or pre-configured, or configured by a higher-layer signaling. In some embodiments, the higher-layer signaling includes at least one of: an RRC message, or a MAC CE.

In some embodiments, the time granularity, the offset value and the candidate value set are fixed values. In some embodiments, multiple sets of candidate items exist, and the candidate items include at least one of: the time granularity, the offset value, or the candidate value set. That is, for one or more of the time granularity, the offset value, or the candidate value set, there are multiple sets of values. The candidate item(s) used for determining the time-domain gap are determined based on at least one of: a capability of the zero-power device; data content for the data transmission; a data type for the data transmission; a modulation manner for the data transmission; a type of a synchronization signal; or an indication of a higher layer signaling.

In some embodiments, for the specific implementations regarding the second control signaling indicating the time-frequency resources for the data transmission, the reference may be made to the relevant description of the above third control signaling, which will not be repeated in the embodiments of the present disclosure.

In summary, according to the method provided in this embodiment, by using the control signaling to schedule the time-frequency synchronization and data transmission of the zero-power device, this can ensure that sufficient time is reserved for the zero-power device to perform time-frequency synchronization prior to the data transmission, and a long waiting delay for data transmission is avoided, thereby helping to ensure the time-frequency accuracy of the zero-power device and improving the reliability of data transmission and/or reception of the zero-power device.

According to the methods provided by the embodiments of the present disclosure, a two-step control signaling is used for scheduling a time-frequency synchronization procedure and data transmission of a zero-power device; or a single-step control signaling is used for simultaneously triggering the zero-power device to perform time-frequency synchronization and scheduling data transmission of the zero-power device. By scheduling the time-frequency synchronization and data transmission of the zero-power device through the control signaling, it can be ensured that sufficient time is reserved for the zero-power device to perform the time-frequency synchronization before the data transmission, and a long waiting delay for data transmission is avoided, thereby helping to ensure the time-frequency accuracy of the zero-power device and improving the reliability of data transmission and/or reception of the zero-power device.

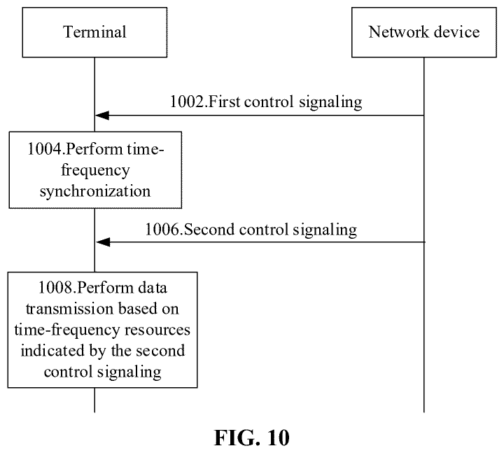

For the case where the control signaling is the two-step control signaling (i.e., the 2-step control signaling). FIG. 10 is a flowchart of a data transmission method provided by an exemplary embodiment of the present disclosure. The method includes operations 1002, 1004, 1006 and 1008.

The operation 1002: a network device sends a first control signaling to a zero-power device.

The first control signaling is used to trigger the zero-power device to perform time-frequency synchronization. The time-frequency synchronization includes at least one of time synchronization or frequency synchronization.

In some embodiments, the first control signaling includes at least one of: a trigger signal, information related to the time-frequency synchronization, device information of a target device, or information related to the second control signaling.

In some embodiments, the trigger signal is used for triggering (waking up) the zero-power device to activate its crystal oscillator for a time-frequency synchronization procedure, to enable subsequent data transmission. The target device includes a device that performs the data transmission with the zero-power device. In some embodiments, the device information of the target device includes at least one of device identification information or device group identification information.

In some embodiments, the information related to the time-frequency synchronization includes at least one of: an accuracy requirement for the time-frequency synchronization, a synchronization time for the time-frequency synchronization, a modulation manner for the data transmission, or a type of a synchronization signal.

In some embodiments, the accuracy requirement for the time-frequency synchronization is used by the zero-power device to estimate/determine the synchronization time (synchronization duration) required for the time-frequency synchronization. In some embodiments, the synchronization time required for the time-frequency synchronization is positively correlated with the accuracy of the time-frequency synchronization.

In some embodiments, the modulation manner for the data transmission is used by the zero-power device to estimate/determine the synchronization time required for the time-frequency synchronization.

In some embodiments, the synchronization signal includes signal(s) used by the zero-power device for the time-frequency synchronization. In some embodiments, the type of the synchronization signal includes at least one of: a type of a sequence used for the synchronization signal, a waveform of the synchronization signal, a frequency-domain position of the synchronization signal, a period of the synchronization signal, or a duty cycle of the synchronization signal. In some embodiments, the type of the synchronization signal is used by the zero-power device to estimate/determine the synchronization time required for the time-frequency synchronization. The synchronization signal may directly follow the synchronization signal from the related technologies or may be a newly redesigned synchronization signal. In some embodiments, in a WLAN system, the synchronization signal may be the same as or different from a WUR Sync signal.

In some embodiments, based on the modulation manner and/or other information (e.g., the above accuracy requirement, the synchronization signal) for the data transmission, the zero-power device may determine an approximate time required for the time-frequency synchronization.

In some embodiments, a unit of the synchronization time includes at least one of: a radio frame (or referred to as a frame), a subframe, a slot, a symbol, or a millisecond (ms). In some embodiments, because the zero-power device will also receive the second control signaling at a time point for scheduling data transmission, the synchronization time for the zero-power device to perform the time-frequency synchronization is less than (slightly less than) a time-domain gap from the first control signaling to the data transmission. After determining the synchronization time for the time-frequency synchronization, the zero-power device may infer an approximate time point of the second control signaling.

In some embodiments, the information related to the time-frequency synchronization is indicated by a field carried in the first control signaling from multiple candidate values, or is indicated by a generation sequence used by the first control signaling from multiple candidate values. In some embodiments, the multiple candidate values are preset, or pre-configured, or configured by a higher-layer signaling.

In some embodiments, the information related to the second control signaling includes at least one of: a time-domain gap between the first control signaling and the second control signaling, a monitoring time window for the second control signaling, time-frequency resources for the second control signaling, or a modulation manner for the second control signaling.

In some embodiments, the modulation manner includes a modulation manner in MCS.

Considering the uncertainty of resource scheduling and LBT, the network device may not be able to accurately predict the time-domain resources for the second control signaling when transmitting the first control signaling. However, the network device can provide an approximate time window (the monitoring time window) to facilitate monitoring by the zero-power device. To facilitate monitoring by the zero-power device, the first control signaling is typically designed to be as simple as possible, with minimal payload and occupying a much smaller bandwidth. In contrast, the payload, modulation and coding scheme, etc., of the second control signaling may be significantly more complex than those of the first control signaling.

The operation 1004: the zero-power device performs time-frequency synchronization.

In some embodiments, after receiving the first control signaling, the zero-power device begins receiving the synchronization signal to perform the time-frequency synchronization. For example, it may receive the synchronization signal more frequently according to a shorter period, or wake up the MR to perform the synchronization procedure.

The second control signaling is used for indicating the specific time-frequency resources for the data transmission of the zero-power device.

The operation 1006: the network device sends a second control signaling to the zero-power device.

The second control signaling is used for indicating time-frequency resources for the data transmission of the zero-power device. The second control signaling is used for indicating the specific time-frequency resources used for the zero-power device to send and/or receive data. The time-frequency resources include at least one of a time-domain resource or a frequency-domain resource. In some embodiments, the second control signaling is after the first control signaling or the first control signaling is before the second control signaling. This sequential order includes a time-domain precedence relationship.

In some embodiments, for unlicensed spectrum, the network device can determine the resources allocated to the zero-power device only after successfully obtaining a channel through LBT. Additionally, the COT obtained by the network device in each LBT is relatively limited. If the time required for the synchronization procedure is too long, it may actually exceed the duration of the COT even if it has already been allocated via the first control signaling. Therefore, when the synchronization procedure requires the longer time, regardless of whether the 2-step control signaling is used, the network device needs to perform LBT again to obtain a channel, so as to determine the resources allocated for the data transmission of the zero-power device. For licensed spectrum, the network device and the zero-power device can use a channel without channel listening, making the advantages of using the 2-step control signaling potentially less significant compared to unlicensed spectrum.

In some embodiments, a time-domain gap K between the first control signaling and the data transmission of the zero-power device (or the synchronization time T for the time-frequency synchronization, or a time-domain gap between the first control signaling and the second control signaling) is controlled by the network device (e.g., AP) sending the control signaling. The network device may determine the time-domain gap based on the following factors.

The factors may include a data type for the data transmission, a modulation manner for the data transmission, and/or the like.

The factors may include a capability of the zero-power device.

The factors may include characteristics of the synchronization signal, for example, the length, period, transmission duty cycle, waveform, and/or modulation manner of the synchronization signal.

In some embodiments, the time-domain gap K reserved by the network device is greater than or equal to the actually required synchronization time determined by the zero-power device based on the first control signaling.

In some embodiments, at least one of the first control signaling or the second control signaling further includes at least one of: data content for the data transmission, a data type for the data transmission, or a modulation manner for the data transmission.

In some embodiments, if the same information is indicated in both the first control signaling and the second control signaling, the first control signaling and the second control signaling may be allowed to indicate different values for that same information. The zero-power device uses the value indicated by the second control signaling for the data transmission.

In some embodiments, the synchronization signal (e.g., a beacon frame) can be provided by different devices or on different frequency points. This approach enables the zero-power device to, in most cases, only need to monitor the first control signaling and a part of downlink signals. The zero-power device is triggered to perform the time-frequency synchronization only when the data transmission is required. Furthermore, in the 2-step control signaling, the first control signaling and the signaling overhead thereof can be made as simple as possible, thereby reducing the complexity and power consumption for the zero-power device to monitor and detect the first control signaling.

The operation 1008: the zero-power device performs data transmission based on time-frequency resources indicated by the second control signaling.

The data transmission of the zero-power device includes at least one of data receiving or data sending. In some embodiments, “data sending” includes “sending in uplink” (i.e., transmit via an uplink), for example, the zero-power device sends/transmits data to the network device (base station, AP, etc.). Moreover, “data sending” may further include “sending in sidelink” (i.e., transmit via a sidelink), for example, the zero-power device sends/transmits data to another user equipment (mobile phone, computer, another zero-power device, etc.) via a sidelink. In some embodiments, “data receiving” includes “receiving downlink data” (i.e., receive via a downlink), for example, receiving data transmitted by the network device (base station, AP, etc.). Moreover, “data receiving” may further include “sidelink reception” (i.e., receive via a sidelink), for example, receiving data transmitted by another user equipment (mobile phone, computer, another zero-power device, etc.) via a sidelink.

In some embodiments, for the specific implementations regarding the second control signaling indicating the time-frequency resources for the data transmission, the reference may be made to the relevant description of the third control signaling involved in other embodiments above, which will not be repeated in the embodiments of the present disclosure.

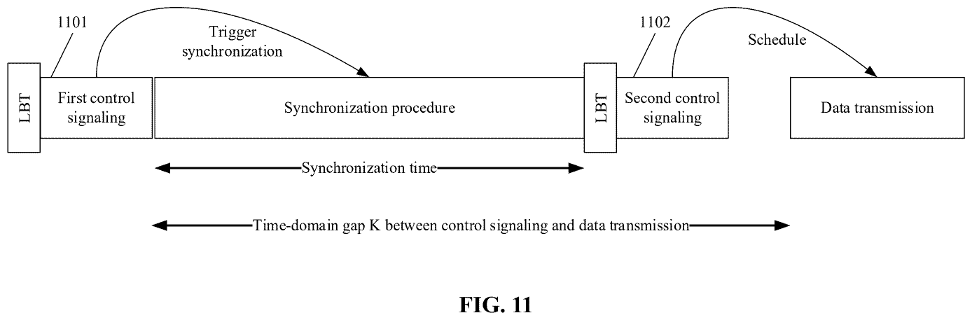

By way of example, FIG. 11 is a diagram of a process of scheduling data transmission provided by an exemplary embodiment of the present disclosure. As illustrated in FIG. 11, a network device obtains a channel via LBT and accordingly transmits a first control signaling 1101 to a zero-power device. The first control signaling 1101 triggers the zero-power device to perform time-frequency synchronization. The network device also obtains resources via LBT and accordingly indicates, through a second control signaling 1102, time-frequency resources for data transmission to the zero-power device. It should be noted that the aforementioned LBT procedures are not mandatory. Typically, only for unlicensed spectrum, LBT is required to obtain the channel. For licensed spectrum, transmission may be performed directly on designated time-domain resources without any LBT procedure. If a time-domain gap K between the first control signaling 1101 and the data transmission is relatively small, such that both the first control signaling and the data transmission fall within the same COT (e.g., 8 ms), then the second LBT is not required.

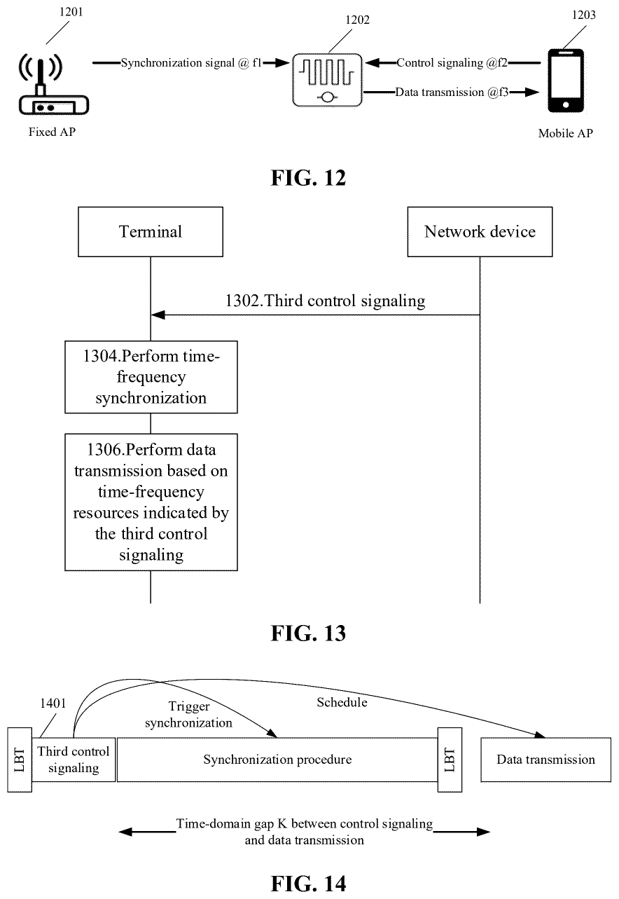

By way of example, FIG. 12 is a diagram of a signaling transmission process provided by an exemplary embodiment of the present disclosure. As illustrated in FIG. 12, a mobile AP 1203 transmits a control signaling to a zero-power device 1202 on a frequency point f2, so as to trigger the zero-power device 1202 to perform time-frequency synchronization and indicate time-frequency resources for data transmission. A fixed AP 1201 transmits a synchronization signal to the zero-power device 1202 on a frequency point f1 via a beacon frame, and the zero-power device 1202 performs time-frequency synchronization accordingly. Based on the time-frequency resources indicated by the control signaling, the zero-power device 1202 transmits data to the mobile AP 1203 on a frequency point f3. In some embodiments, some of the frequency point f1 of the beacon frame, the downlink frequency point f2, and the uplink frequency point f3 may be the same. If f1 differs from f2, the zero-power device 1202 monitors the control signaling from the AP on the frequency point f1 and, after being woken up/triggered upon receiving the first control signaling, completes synchronization based on the synchronization signal on the frequency point f2, and then monitors for the second control signaling within the corresponding time window.

In this embodiment, the operations 1002, 1004, 1006, and 1008 are optional. In different embodiments, one or more of these operations may be omitted or substituted.

The operation 1002 may be implemented as an independent embodiment, for example, separately implemented as a control signaling transmission method on the zero-power device side or the network device side. The operation 1004 may be implemented as an independent embodiment, for example, separately implemented as a synchronization method on the zero-power device side. The operation 1006 may be implemented as an independent embodiment, for example, separately implemented as a control signaling transmission method on the zero-power device side or the network device side. The operation 1008 may be implemented as an independent embodiment, for example, separately implemented as a data transmission method on the zero-power device side.

In summary, according to the method provided in this embodiment, by using the control signaling to schedule the time-frequency synchronization and data transmission of the zero-power device, this can ensure that sufficient time is reserved for the zero-power device to perform time-frequency synchronization prior to the data transmission, and a long waiting delay for data transmission is avoided, thereby helping to ensure the time-frequency accuracy of the zero-power device and improving the reliability of data transmission and/or reception of the zero-power device.

Furthermore, by using the two-step control signaling to schedule the time-frequency synchronization and data transmission of the zero-power device respectively, the scheduling of data transmission is separated from the time-frequency synchronization procedure, thereby enabling flexible scheduling of the time-frequency resources for the data transmission. The information in the first control signaling allows the zero-power device to determine the synchronization time required for its time-frequency synchronization. By information carried in the first control signaling to indicate information from candidate values, the first control signaling can be simplified, reducing signaling overhead. Indication of information related to the second control signaling in the first control signaling facilitates the zero-power device's monitoring for the second control signaling. Carrying information related to the data to be transmitted in the control signaling contributes to accurate data transmission.

For the case where the control signaling is the single-step control signaling. FIG. 13 is a flowchart of a data transmission method provided by an exemplary embodiment of the present disclosure. The method includes operations 1302, 1304 and 1306.

The operation 1302: a network device transmits a third control signaling to a zero-power device.

The third control signaling is used for simultaneously triggering the zero-power device to perform time-frequency synchronization and indicating time-frequency resources for data transmission of the zero-power device.

In some embodiments, the third control signaling includes a first field and a second field. The first field is used for indicating information related to the time-frequency synchronization, and the second field is used for indicating the time-frequency resources for the data transmission. For the contents and indication methods of the information related to the time-frequency synchronization, the reference may be made to the relevant contents in other embodiments above, which will not be repeated in the embodiments of the present disclosure.

In some embodiments, the third control signaling includes a second field. The second field is used for indicating (explicitly indicating) the time-frequency resources for the data transmission. In this case, the third control signaling is used for implicitly triggering the zero-power device to perform the time-frequency synchronization, and further triggering the zero-power device to determine the synchronization time for the time-frequency synchronization. In some embodiments, after receiving the third control signaling, the zero-power device will automatically trigger the execution of the time-frequency synchronization procedure until the indicated time for the data transmission.

In some embodiments, since a time-domain position for the data transmission is known (indicated by the third control signaling), the zero-power device can autonomously perform the time-frequency synchronization before the data transmission, based on implementation of the zero-power device.

In some embodiments, for unlicensed spectrum, before the data transmission, the zero-power device needs to first obtain a channel via UL LBT, or the network device obtains a channel via DL LBT and shares COT resources to the zero-power device.

In some embodiments, the time-frequency resources for the data transmission indicated by the third control signaling include a time-domain position for the data transmission. In some embodiments, the time-frequency resources for the data transmission indicated by the third control signaling include a time-domain gap between the data transmission and the third control signaling.

In some embodiments, a unit of the time-domain gap includes at least one of a radio frame, a subframe, a slot, a symbol, or a millisecond.

Considering that the time-domain gap required for the time-frequency synchronization, which is influenced by factors such as the capability of the zero-power device and the required synchronization accuracy, ranges from several milliseconds to several hundred milliseconds, if the time-domain gap is directly indicated in the third control signaling, this results in larger signaling overhead. To reduce the signaling overhead of the third control signaling, one or any combination of the following manners may be adopted.

In some embodiments, the time-domain gap is indicated by a product of a first indication value carried in the third control signaling and a time granularity.

In some embodiments, the time-domain gap is indicated by a sum of a second indication value carried in the third control signaling and an offset value.

In some embodiments, the time-domain gap is indicated by a sum of a product and an offset value, where the product is a product of a first indication value carried in the third control signaling and a time granularity.

In some embodiments, the time-domain gap is indicated by a third indication value carried in the third control signaling from a candidate value set.

In some embodiments, the time granularity, the offset value and the candidate value set are preset, or pre-configured, or configured by a higher-layer signaling. In some embodiments, the higher-layer signaling includes at least one of: an RRC message, or a MAC CE.

In some embodiments, the time granularity, the offset value and the candidate value set are fixed values. In some embodiments, multiple sets of candidate items exist, and the candidate items include at least one of: the time granularity, the offset value, or the candidate value set. That is, for one or more of the time granularity, the offset value, or the candidate value set, there are multiple sets of values. The candidate item(s) used for determining the time-domain gap are determined based on at least one of: a capability of the zero-power device; data content for the data transmission; a data type for the data transmission; a modulation manner for the data transmission; a type of a synchronization signal; or an indication of a higher layer signaling.

The operation 1304: the zero-power device performs time-frequency synchronization.

In some embodiments, after receiving the third control signaling, the zero-power device begins receiving the synchronization signal to perform the time-frequency synchronization. For example, it may receive the synchronization signal more frequently according to a shorter period, or wake up the MR to perform the synchronization procedure. The zero-power device also can determine the synchronization time for the time-frequency synchronization of the zero-power device.

The operation 1306: the zero-power device performs data transmission based on time-frequency resources indicated by the third control signaling.

The data transmission of the zero-power device includes at least one of data receiving or data sending. In some embodiments, “data sending” includes “sending in uplink” (i.e., transmit via an uplink), for example, the zero-power device sends/transmits data to the network device (base station, AP, etc.). Moreover, “data sending” may further include “sending in sidelink” (i.e., transmit via a sidelink), for example, the zero-power device sends/transmits data to another user equipment (mobile phone, computer, another zero-power device, etc.) via a sidelink. In some embodiments, “data receiving” includes “receiving downlink data” (i.e., receive via a downlink), for example, receiving data transmitted by the network device (base station, AP, etc.). Moreover, “data receiving” may further include “sidelink reception” (i.e., receive via a sidelink), for example, receiving data transmitted by another user equipment (mobile phone, computer, another zero-power device, etc.) via a sidelink.

By way of example, FIG. 14 is a diagram of a process of scheduling data transmission provided by an exemplary embodiment of the present disclosure. As illustrated in FIG. 14, a network device obtains a channel via LBT and accordingly transmits a third control signaling 1401 to a zero-power device. The third control signaling 1401 triggers the zero-power device to perform time-frequency synchronization and indicates time-frequency resources for data transmission of the zero-power device. It should be noted that the aforementioned LBT procedure is not mandatory. Typically, only for unlicensed spectrum, LBT is required to obtain the channel. For licensed spectrum, transmission may be performed directly on designated time-domain resources without any LBT procedure. If a time-domain gap K between the third control signaling 1401 and the data transmission is relatively small, such that both the third control signaling 1401 and the data transmission fall within the same COT (e.g., 8 ms), then the second LBT is not required. The network device obtains a COT of 8 ms via the first LBT, transmits the third control signaling 1401 in an earlier portion of the COT, and instructs the zero-power device to perform the time-frequency synchronization and the data transmission in a latter portion of the COT.

In this embodiment, the operations 1302, 1304, and 1306 are optional. In different embodiments, one or more of these operations may be omitted or substituted.

The operation 1302 may be implemented as an independent embodiment, for example, separately implemented as a control signaling transmission method on the zero-power device side or the network device side. The operation 1304 may be implemented as an independent embodiment, for example, separately implemented as a synchronization method on the zero-power device side. The operation 1306 may be implemented as an independent embodiment, for example, separately implemented as a data transmission method on the zero-power device side.

In summary, according to the method provided in this embodiment, by using the control signaling to schedule the time-frequency synchronization and data transmission of the zero-power device, this can ensure that sufficient time is reserved for the zero-power device to perform time-frequency synchronization prior to the data transmission, and a long waiting delay for data transmission is avoided, thereby helping to ensure the time-frequency accuracy of the zero-power device and improving the reliability of data transmission and/or reception of the zero-power device.

Furthermore, by using the single-step control signaling to simultaneously schedule both time-frequency synchronization and data transmission of the zero-power device, signaling overhead can be reduced and scheduling efficiency can be improved. By carrying only a field that indicates time-frequency resources for data transmission, the complexity of the third control signaling can be reduced. By indicating a time-domain gap rather than a specific time-domain position, the complexity of the indication information can be reduced. By using an indication value carried in the third control signaling in conjunction with a time granularity, an offset value, and/or a candidate value set to jointly indicate the time-domain gap, the complexity of the indication information can be reduced, thereby reducing signaling overhead. By configuring multiple sets of candidate items, the time-domain gap can be flexibly indicated for different scenarios.

It should be noted that the sequence of the method operations provided in the embodiments of the present disclosure may be appropriately adjusted, the operations may be added or removed as needed, and different operations may be freely combined to form new embodiments. Any variations that can be easily conceived by those skilled in the art within the technical scope disclosed in the present disclosure shall fall within the protection scope of the present disclosure and will not be repeated herein. Additionally, the order of the different cases mentioned above does not imply any preference and is provided solely for convenience of description.

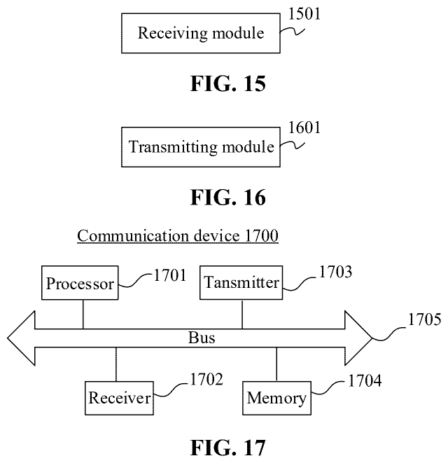

FIG. 15 is a block diagram of a zero-power apparatus provided by an exemplary embodiment of the present disclosure. The apparatus may be implemented as a zero-power device or a part of a zero-power device by software or hardware or a combination of both. The apparatus includes a receiving module 1501.

The receiving module 1501 is configured to receive a control signaling, here, the control signaling is used for triggering the zero-power apparatus to perform time-frequency synchronization and indicating time-frequency resources for data transmission.

In some embodiments, the control signaling is used for simultaneously triggering the zero-power device to perform the time-frequency synchronization and indicating the time-frequency resources for the data transmission of the zero-power device. In some embodiments, the control signaling is used for separately triggering the zero-power device to perform the time-frequency synchronization and indicating the time-frequency resources for the data transmission of the zero-power device. The time-frequency synchronization includes at least one of time synchronization or frequency synchronization. The time-frequency resources include at least one of a time-domain resource or a frequency-domain resource.

The data transmission of the zero-power device includes at least one of data receiving or data sending. In some embodiments, “data sending” includes “sending in uplink” (i.e., transmit via an uplink), for example, the zero-power device sends/transmits data to the network device (base station, AP, etc.). Moreover, “data sending” may further include “sending in sidelink” (i.e., transmit via a sidelink), for example, the zero-power device sends/transmits data to another user equipment (mobile phone, computer, another zero-power device, etc.) via a sidelink. In some embodiments, “data receiving” includes “receiving downlink data” (i.e., receive via a downlink), for example, receiving data transmitted by the network device (base station, AP, etc.). Moreover, “data receiving” may further include “sidelink reception” (i.e., receive via a sidelink), for example, receiving data transmitted by another user equipment (mobile phone, computer, another zero-power device, etc.) via a sidelink.

In some embodiments, after receiving the control signaling, the zero-power device performs the time-frequency synchronization based on indication of the control signaling, and performs the data transmission based on the time-frequency resources indicated by the control signaling.

### For the Case Where the Control Signaling is 2-Step Controlling Signaling

The control signaling includes a first control signaling (the first-step control signaling, control 1) and a second control signaling (the second-step control signaling, control 2). The first control signaling is used for triggering the zero-power device to perform the time-frequency synchronization, and the second control signaling is used for indicating the time-frequency resources for the data transmission of the zero-power device.

In some embodiments, the second control signaling is after the first control signaling or the first control signaling is before the second control signaling. This sequential order includes a sequential relationship in a time domain.

In some embodiments, the first control signaling includes at least one of: a trigger signal, information related to the time-frequency synchronization, device information of a target device, or information related to the second control signaling.

In some embodiments, the trigger signal is used for triggering (waking up) the zero-power device to activate its crystal oscillator for a time-frequency synchronization procedure, to enable subsequent data transmission. The target device includes a device that performs the data transmission with the zero-power device. In some embodiments, the device information of the target device includes at least one of device identification information or device group identification information.

In some embodiments, the information related to the time-frequency synchronization includes at least one of: an accuracy requirement for the time-frequency synchronization, a synchronization time for the time-frequency synchronization, a modulation manner for the data transmission, or a type of a synchronization signal.

In some embodiments, the accuracy requirement for the time-frequency synchronization is used by the zero-power device to estimate/determine the synchronization time (synchronization duration) required for the time-frequency synchronization. In some embodiments, the synchronization time required for the time-frequency synchronization is positively correlated with the accuracy of the time-frequency synchronization.

In some embodiments, the modulation manner for the data transmission is used by the zero-power device to estimate/determine the synchronization time required for the time-frequency synchronization.

In some embodiments, the synchronization signal includes signal(s) used by the zero-power device for the time-frequency synchronization. In some embodiments, the type of the synchronization signal includes at least one of: a type of a sequence used for the synchronization signal, a waveform of the synchronization signal, a frequency-domain position of the synchronization signal, a period of the synchronization signal, or a duty cycle of the synchronization signal. In some embodiments, the type of the synchronization signal is used by the zero-power device to estimate/determine the synchronization time required for the time-frequency synchronization. The synchronization signal may directly follow the synchronization signal from the related technologies or may be a newly redesigned synchronization signal. In some embodiments, in a WLAN system, the synchronization signal may be the same as or different from a WUR Sync signal.

In some embodiments, based on the modulation manner and/or other information (e.g., the above accuracy requirement, the synchronization signal) for the data transmission, the zero-power device may determine an approximate time required for the time-frequency synchronization.

In some embodiments, a unit of the synchronization time includes at least one of: a radio frame (or referred to as a frame), a subframe, a slot, a symbol, or a millisecond (ms). In some embodiments, because the zero-power device will also receive the second control signaling at a time point for scheduling data transmission, the synchronization time for the zero-power device to perform the time-frequency synchronization is less than (slightly less than) a time-domain gap from the first control signaling to the data transmission. After determining the synchronization time for the time-frequency synchronization, the zero-power device may infer an approximate time point of the second control signaling.

In some embodiments, the information related to the time-frequency synchronization is indicated by a field carried in the first control signaling from multiple candidate values, or is indicated by a generation sequence used by the first control signaling from multiple candidate values. In some embodiments, the multiple candidate values are preset, or pre-configured, or configured by a higher-layer signaling.

In some embodiments, the information related to the second control signaling includes at least one of: a time-domain gap between the first control signaling and the second control signaling, a monitoring time window for the second control signaling, time-frequency resources for the second control signaling, or a modulation manner for the second control signaling.

In some embodiments, the modulation manner includes a modulation manner in MCS.

Considering the uncertainty of resource scheduling and LBT, the network device may not be able to accurately predict the time-domain resources for the second control signaling when transmitting the first control signaling. However, the network device can provide an approximate time window (the monitoring time window) to facilitate monitoring by the zero-power device. To facilitate monitoring by the zero-power device, the first control signaling is typically designed to be as simple as possible, with minimal payload and occupying a much smaller bandwidth. In contrast, the payload, modulation and coding scheme, etc., of the second control signaling may be significantly more complex than those of the first control signaling.

In some embodiments, after receiving the first control signaling, the zero-power device begins receiving the synchronization signal to perform the time-frequency synchronization. For example, it may receive the synchronization signal more frequently according to a shorter period, or wake up the MR to perform the synchronization procedure.

The second control signaling is used for indicating the specific time-frequency resources for the data transmission of the zero-power device.

In some embodiments, for unlicensed spectrum, the network device can determine the resources allocated to the zero-power device only after successfully obtaining a channel through LBT. Additionally, the COT obtained by the network device in each LBT is relatively limited. If the time required for the synchronization procedure is too long, it may actually exceed the duration of the COT even if it has already been allocated via the first control signaling. Therefore, when the synchronization procedure requires the longer time, regardless of whether the 2-step control signaling is used, the network device needs to perform LBT again to obtain a channel, so as to determine the resources allocated for the data transmission of the zero-power device. For licensed spectrum, the network device and the zero-power device can use a channel without channel listening, making the advantages of using the 2-step control signaling potentially less significant compared to unlicensed spectrum.

In some embodiments, a time-domain gap K between the first control signaling and the data transmission of the zero-power device (or the synchronization time T for the time-frequency synchronization, or a time-domain gap between the first control signaling and the second control signaling) is controlled by the network device (e.g., AP) sending the control signaling. The network device may determine the time-domain gap based on the following factors.

The factors may include a data type for the data transmission, a modulation manner for the data transmission, and/or the like.

The factors may include a capability of the zero-power device.

The factors may include characteristics of the synchronization signal, for example, the length, period, transmission duty cycle, waveform, and/or modulation manner of the synchronization signal.

In some embodiments, the time-domain gap K reserved by the network device is greater than or equal to the actually required synchronization time determined by the zero-power device based on the first control signaling.

In some embodiments, at least one of the first control signaling or the second control signaling further includes at least one of: data content for the data transmission, a data type for the data transmission, or a modulation manner for the data transmission.

In some embodiments, if the same information is indicated in both the first control signaling and the second control signaling, the first control signaling and the second control signaling may be allowed to indicate different values for that same information. The zero-power device uses the value indicated by the second control signaling for the data transmission.

In some embodiments, the synchronization signal (e.g., a beacon frame) can be provided by different devices or on different frequency points. This approach enables the zero-power device to, in most cases, only need to monitor the first control signaling and a part of downlink signals. The zero-power device is triggered to perform the time-frequency synchronization only when the data transmission is required. Furthermore, in the 2-step control signaling, the first control signaling and the signaling overhead thereof can be made as simple as possible, thereby reducing the complexity and power consumption for the zero-power device to monitor and detect the first control signaling.

### For the Case Where the Control Signaling is Single-Step Controlling Signaling

The control signaling includes a third control signaling (the single-step control signaling). The third control signaling is used for simultaneously triggering the zero-power device to perform the time-frequency synchronization and indicating the time-frequency resources for the data transmission of the zero-power device.

In some embodiments, the third control signaling includes a first field and a second field. The first field is used for indicating information related to the time-frequency synchronization, and the second field is used for indicating the time-frequency resources for the data transmission. For the contents and indication methods of the information related to the time-frequency synchronization, the reference may be made to the foregoing relevant contents, which will not be repeated in the embodiments of the present disclosure.

In some embodiments, the third control signaling includes a second field. The second field is used for indicating (explicitly indicating) the time-frequency resources for the data transmission. In this case, the third control signaling is used for implicitly triggering the zero-power device to perform the time-frequency synchronization, and further triggering the zero-power device to determine the synchronization time for the time-frequency synchronization. In some embodiments, after receiving the third control signaling, the zero-power device will automatically trigger the execution of the time-frequency synchronization procedure until the indicated time for the data transmission.

In some embodiments, since a time-domain position for the data transmission is known (indicated by the third control signaling), the zero-power device can autonomously perform the time-frequency synchronization before the data transmission, based on implementation of the zero-power device.

In some embodiments, for unlicensed spectrum, before the data transmission, the zero-power device needs to first obtain a channel via UL LBT, or the network device obtains a channel via DL LBT and shares COT resources to the zero-power device.

In some embodiments, the time-frequency resources for the data transmission indicated by the third control signaling include a time-domain position for the data transmission. In some embodiments, the time-frequency resources for the data transmission indicated by the third control signaling include a time-domain gap between the data transmission and the third control signaling.

In some embodiments, a unit of the time-domain gap includes at least one of a radio frame, a subframe, a slot, a symbol, or a millisecond.

Considering that the time-domain gap required for the time-frequency synchronization, which is influenced by factors such as the capability of the zero-power device and the required synchronization accuracy, ranges from several milliseconds to several hundred milliseconds, if the time-domain gap is directly indicated in the third control signaling, this results in larger signaling overhead. To reduce the signaling overhead of the third control signaling, one or any combination of the following manners may be adopted.

In some embodiments, the time-domain gap is indicated by a product of a first indication value carried in the third control signaling and a time granularity.

In some embodiments, the time-domain gap is indicated by a sum of a second indication value carried in the third control signaling and an offset value.

In some embodiments, the time-domain gap is indicated by a sum of a product and an offset value, where the product is a product of a first indication value carried in the third control signaling and a time granularity.

In some embodiments, the time-domain gap is indicated by a third indication value carried in the third control signaling from a candidate value set.

In some embodiments, the time granularity, the offset value and the candidate value set are preset, or pre-configured, or configured by a higher-layer signaling. In some embodiments, the higher-layer signaling includes at least one of: an RRC message, or a MAC CE.

In some embodiments, the time granularity, the offset value and the candidate value set are fixed values. In some embodiments, multiple sets of candidate items exist, and the candidate items include at least one of: the time granularity, the offset value, or the candidate value set. That is, for one or more of the time granularity, the offset value, or the candidate value set, there are multiple sets of values. The candidate item(s) used for determining the time-domain gap are determined based on at least one of: a capability of the zero-power device; data content for the data transmission; a data type for the data transmission; a modulation manner for the data transmission; a type of a synchronization signal; or an indication of a higher layer signaling.

In some embodiments, for the specific implementations regarding the second control signaling indicating the time-frequency resources for the data transmission, the reference may be made to the relevant description of the above third control signaling, which will not be repeated in the embodiments of the present disclosure.

In some embodiments, the apparatus provided by the embodiment of the present disclosure includes one receiving module 1501, and this receiving module 1501 supports the execution of all receiving-related operations performed by the zero-power device in each of the above embodiments.

In some embodiments, the apparatus provided by the embodiment of the present disclosure includes multiple receiving modules 1501, and the multiple receiving modules 1501 each supports the execution of part of the receiving-related operations performed by the zero-power device in each of the above embodiments.

In some embodiments, the operations performed by different receiving modules 1501 are exactly the same, or partially the same, or completely different.

In summary, according to the apparatus provided in this embodiment, by using the control signaling to schedule the time-frequency synchronization and data transmission of the zero-power device, this can ensure that prior to the data transmission, sufficient time is reserved for the zero-power device to perform time-frequency synchronization, and a long waiting delay for data transmission is avoided, thereby helping to ensure the time-frequency accuracy of the zero-power device and improving the reliability of data transmission and/or reception of the zero-power device.

FIG. 16 is a block diagram of a network-side apparatus provided by an exemplary embodiment of the present disclosure. The apparatus may be implemented as a network device or a part of a network device by software or hardware or a combination of both. The apparatus includes a transmitting module 1601.

The transmission module 1601 is configured to send a control signaling, here, the control signaling is used for triggering a zero-power device to perform time-frequency synchronization, and indicating time-frequency resources for data transmission.

In some embodiments, the control signaling is used for simultaneously triggering the zero-power device to perform the time-frequency synchronization and indicating the time-frequency resources for the data transmission of the zero-power device. In some embodiments, the control signaling is used for separately triggering the zero-power device to perform the time-frequency synchronization and indicating the time-frequency resources for the data transmission of the zero-power device. The time-frequency synchronization includes at least one of time synchronization or frequency synchronization. The time-frequency resources include at least one of a time-domain resource or a frequency-domain resource.

The data transmission of the zero-power device includes at least one of data receiving or data sending. In some embodiments, “data sending” includes “sending in uplink” (i.e., transmit via an uplink), for example, the zero-power device sends/transmits data to the network device (base station, AP, etc.). Moreover, “data sending” may further include “sending in sidelink” (i.e., transmit via a sidelink), for example, the zero-power device sends/transmits data to another user equipment (mobile phone, computer, another zero-power device, etc.) via a sidelink. In some embodiments, “data receiving” includes “receiving downlink data” (i.e., receive via a downlink), for example, receiving data transmitted by the network device (base station, AP, etc.). Moreover, “data receiving” may further include “sidelink reception” (i.e., receive via a sidelink), for example, receiving data transmitted by another user equipment (mobile phone, computer, another zero-power device, etc.) via a sidelink.

In some embodiments, after receiving the control signaling, the zero-power device performs the time-frequency synchronization based on indication of the control signaling, and performs the data transmission based on the time-frequency resources indicated by the control signaling.

### For the Case Where the Control Signaling is 2-Step Controlling Signaling

The control signaling includes a first control signaling (the first-step control signaling, control 1) and a second control signaling (the second-step control signaling, control 2). The first control signaling is used for triggering the zero-power device to perform the time-frequency synchronization, and the second control signaling is used for indicating the time-frequency resources for the data transmission of the zero-power device.

In some embodiments, the second control signaling is after the first control signaling or the first control signaling is before the second control signaling. This sequential order includes a sequential relationship in a time domain.

In some embodiments, the first control signaling includes at least one of: a trigger signal, information related to the time-frequency synchronization, device information of a target device, or information related to the second control signaling.

In some embodiments, the trigger signal is used for triggering (waking up) the zero-power device to activate its crystal oscillator for a time-frequency synchronization procedure, to enable subsequent data transmission. The target device includes a device that performs the data transmission with the zero-power device. In some embodiments, the device information of the target device includes at least one of device identification information or device group identification information.

In some embodiments, the information related to the time-frequency synchronization includes at least one of: an accuracy requirement for the time-frequency synchronization, a synchronization time for the time-frequency synchronization, a modulation manner for the data transmission, or a type of a synchronization signal.

In some embodiments, the accuracy requirement for the time-frequency synchronization is used by the zero-power device to estimate/determine the synchronization time (synchronization duration) required for the time-frequency synchronization. In some embodiments, the synchronization time required for the time-frequency synchronization is positively correlated with the accuracy of the time-frequency synchronization.

In some embodiments, the modulation manner for the data transmission is used by the zero-power device to estimate/determine the synchronization time required for the time-frequency synchronization.

In some embodiments, the synchronization signal includes signal(s) used by the zero-power device for the time-frequency synchronization. In some embodiments, the type of the synchronization signal includes at least one of: a type of a sequence used for the synchronization signal, a waveform of the synchronization signal, a frequency-domain position of the synchronization signal, a period of the synchronization signal, or a duty cycle of the synchronization signal. In some embodiments, the type of the synchronization signal is used by the zero-power device to estimate/determine the synchronization time required for the time-frequency synchronization. The synchronization signal may directly follow the synchronization signal from the related technologies or may be a newly redesigned synchronization signal. In some embodiments, in a WLAN system, the synchronization signal may be the same as or different from a WUR Sync signal.

In some embodiments, based on the modulation manner and/or other information (e.g., the above accuracy requirement, the synchronization signal) for the data transmission, the zero-power device may determine an approximate time required for the time-frequency synchronization.

In some embodiments, a unit of the synchronization time includes at least one of: a radio frame (or referred to as a frame), a subframe, a slot, a symbol, or a millisecond (ms). In some embodiments, because the zero-power device will also receive the second control signaling at a time point for scheduling data transmission, the synchronization time for the zero-power device to perform the time-frequency synchronization is less than (slightly less than) a time-domain gap from the first control signaling to the data transmission. After determining the synchronization time for the time-frequency synchronization, the zero-power device may infer an approximate time point of the second control signaling.

In some embodiments, the information related to the time-frequency synchronization is indicated by a field carried in the first control signaling from multiple candidate values, or is indicated by a generation sequence used by the first control signaling from multiple candidate values. In some embodiments, the multiple candidate values are preset, or pre-configured, or configured by a higher-layer signaling.

In some embodiments, the information related to the second control signaling includes at least one of: a time-domain gap between the first control signaling and the second control signaling, a monitoring time window for the second control signaling, time-frequency resources for the second control signaling, or a modulation manner for the second control signaling.

In some embodiments, the modulation manner includes a modulation manner in MCS.

Considering the uncertainty of resource scheduling and LBT, the network device may not be able to accurately predict the time-domain resources for the second control signaling when transmitting the first control signaling. However, the network device can provide an approximate time window (the monitoring time window) to facilitate monitoring by the zero-power device. To facilitate monitoring by the zero-power device, the first control signaling is typically designed to be as simple as possible, with minimal payload and occupying a much smaller bandwidth. In contrast, the payload, modulation and coding scheme, etc., of the second control signaling may be significantly more complex than those of the first control signaling.

In some embodiments, after receiving the first control signaling, the zero-power device begins receiving the synchronization signal to perform the time-frequency synchronization. For example, it may receive the synchronization signal more frequently according to a shorter period, or wake up the MR to perform the synchronization procedure.

The second control signaling is used for indicating the specific time-frequency resources for the data transmission of the zero-power device.

In some embodiments, for unlicensed spectrum, the network device can determine the resources allocated to the zero-power device only after successfully obtaining a channel through LBT. Additionally, the COT obtained by the network device in each LBT is relatively limited. If the time required for the synchronization procedure is too long, it may actually exceed the duration of the COT even if it has already been allocated via the first control signaling. Therefore, when the synchronization procedure requires the longer time, regardless of whether the 2-step control signaling is used, the network device needs to perform LBT again to obtain a channel, so as to determine the resources allocated for the data transmission of the zero-power device. For licensed spectrum, the network device and the zero-power device can use a channel without channel listening, making the advantages of using the 2-step control signaling potentially less significant compared to unlicensed spectrum.

In some embodiments, a time-domain gap K between the first control signaling and the data transmission of the zero-power device (or the synchronization time T for the time-frequency synchronization, or a time-domain gap between the first control signaling and the second control signaling) is controlled by the network device (e.g., AP) sending the control signaling. The network device may determine the time-domain gap based on the following factors.

The factors may include a data type for the data transmission, a modulation manner for the data transmission, and/or the like.

The factors may include a capability of the zero-power device.

The factors may include characteristics of the synchronization signal, for example, the length, period, transmission duty cycle, waveform, and/or modulation manner of the synchronization signal.

In some embodiments, the time-domain gap K reserved by the network device is greater than or equal to the actually required synchronization time determined by the zero-power device based on the first control signaling.

In some embodiments, at least one of the first control signaling or the second control signaling further includes at least one of: data content for the data transmission, a data type for the data transmission, or a modulation manner for the data transmission.

In some embodiments, if the same information is indicated in both the first control signaling and the second control signaling, the first control signaling and the second control signaling may be allowed to indicate different values for that same information. The zero-power device uses the value indicated by the second control signaling for the data transmission.

In some embodiments, the synchronization signal (e.g., a beacon frame) can be provided by different devices or on different frequency points. This approach enables the zero-power device to, in most cases, only need to monitor the first control signaling and a part of downlink signals. The zero-power device is triggered to perform the time-frequency synchronization only when the data transmission is required. Furthermore, in the 2-step control signaling, the first control signaling and the signaling overhead thereof can be made as simple as possible, thereby reducing the complexity and power consumption for the zero-power device to monitor and detect the first control signaling.

### For the Case Where the Control Signaling is Single-Step Controlling Signaling

The control signaling includes a third control signaling (the single-step control signaling). The third control signaling is used for simultaneously triggering the zero-power device to perform the time-frequency synchronization and indicating the time-frequency resources for the data transmission of the zero-power device.

In some embodiments, the third control signaling includes a first field and a second field. The first field is used for indicating information related to the time-frequency synchronization, and the second field is used for indicating the time-frequency resources for the data transmission. For the contents and indication methods of the information related to the time-frequency synchronization, the reference may be made to the foregoing relevant contents, which will not be repeated in the embodiments of the present disclosure.

In some embodiments, the third control signaling includes a second field. The second field is used for indicating (explicitly indicating) the time-frequency resources for the data transmission. In this case, the third control signaling is used for implicitly triggering the zero-power device to perform the time-frequency synchronization, and further triggering the zero-power device to determine the synchronization time for the time-frequency synchronization. In some embodiments, after receiving the third control signaling, the zero-power device will automatically trigger the execution of the time-frequency synchronization procedure until the indicated time for the data transmission.

In some embodiments, since a time-domain position for the data transmission is known (indicated by the third control signaling), the zero-power device can autonomously perform the time-frequency synchronization before the data transmission, based on implementation of the zero-power device.

In some embodiments, for unlicensed spectrum, before the data transmission, the zero-power device needs to first obtain a channel via UL LBT, or the network device obtains a channel via DL LBT and shares COT resources to the zero-power device.

In some embodiments, the time-frequency resources for the data transmission indicated by the third control signaling include a time-domain position for the data transmission. In some embodiments, the time-frequency resources for the data transmission indicated by the third control signaling include a time-domain gap between the data transmission and the third control signaling.

In some embodiments, a unit of the time-domain gap includes at least one of a radio frame, a subframe, a slot, a symbol, or a millisecond.

Considering that the time-domain gap required for the time-frequency synchronization, which is influenced by factors such as the capability of the zero-power device and the required synchronization accuracy, ranges from several milliseconds to several hundred milliseconds, if the time-domain gap is directly indicated in the third control signaling, this results in larger signaling overhead. To reduce the signaling overhead of the third control signaling, one or any combination of the following manners may be adopted.

In some embodiments, the time-domain gap is indicated by a product of a first indication value carried in the third control signaling and a time granularity.

In some embodiments, the time-domain gap is indicated by a sum of a second indication value carried in the third control signaling and an offset value.

In some embodiments, the time-domain gap is indicated by a sum of a product and an offset value, where the product is a product of a first indication value carried in the third control signaling and a time granularity.

In some embodiments, the time-domain gap is indicated by a third indication value carried in the third control signaling from a candidate value set.

In some embodiments, the time granularity, the offset value and the candidate value set are preset, or pre-configured, or configured by a higher-layer signaling. In some embodiments, the higher-layer signaling includes at least one of: an RRC message, or a MAC CE.

In some embodiments, the time granularity, the offset value and the candidate value set are fixed values. In some embodiments, multiple sets of candidate items exist, and the candidate items include at least one of: the time granularity, the offset value, or the candidate value set. That is, for one or more of the time granularity, the offset value, or the candidate value set, there are multiple sets of values. The candidate item(s) used for determining the time-domain gap are determined based on at least one of: a capability of the zero-power device; data content for the data transmission; a data type for the data transmission; a modulation manner for the data transmission; a type of a synchronization signal; or an indication of a higher layer signaling.

In some embodiments, for the specific implementations regarding the second control signaling indicating the time-frequency resources for the data transmission, the reference may be made to the relevant description of the above third control signaling, which will not be repeated in the embodiments of the present disclosure.

In some embodiments, the apparatus provided by the embodiment of the present disclosure includes one transmitting module 1601, and this transmitting module 1601 supports the execution of all transmitting/sending-related operations performed by the network device in each of the above embodiments.

In some embodiments, the apparatus provided by the embodiment of the present disclosure includes multiple transmitting modules 1601, and the multiple transmitting modules 1601 each supports the execution of part of the transmitting/sending-related operations performed by the network device in each of the above embodiments.

In some embodiments, the operations performed by different transmitting modules 1601 are exactly the same, or partially the same, or completely different.

In summary, according to the apparatus provided in this embodiment, by using the control signaling to schedule the time-frequency synchronization and data transmission of the zero-power device, this can ensure that prior to the data transmission, sufficient time is reserved for the zero-power device to perform time-frequency synchronization, and a long waiting delay for data transmission is avoided, thereby helping to ensure the time-frequency accuracy of the zero-power device and improving the reliability of data transmission and/or reception of the zero-power device.

It should be noted that when the apparatus provided in the above embodiments realizes its functions, the division of the functional modules described above is used only for illustrative purposes. In practical applications, the functions described above may, according to actual needs, be allocated to and performed by different functional modules. That is, the internal structure of the device may be divided into different functional modules so as to accomplish all or part of the functions described above.

With regard to the apparatuses in the above-described embodiments, the specific manners in which the respective modules of the apparatuses perform operations have been described in detail in the embodiments related to the methods, and will not be described in detail here.

FIG. 17 is a structural diagram of a communication device according to an exemplary embodiment of the present disclosure. The communication device is a zero-power device or a network device. The communication device 1700 includes a processor 1701, a receiver 1702, a transmitter 1703, a memory 1704, and a bus 1705.

The processor 1701 includes one or more processing cores, and executes various functional applications and information processing by running software programs and modules.

The receiver 1702 and the transmitter 1703 may be implemented as a communication component, which may be a communication chip.

The memory 1704 is connected to the processor 1701 via the bus 1705. The memory 1704 may be configured to store at least one instruction, and the processor 1701 is configured to execute the at least one instruction to perform various operations in the above-described method embodiments.

Further, the memory 1704 may be implemented by any type of volatile or non-volatile storage device or a combination thereof. The volatile or non-volatile storage device includes, but not limited to, a magnetic or optical disk, an Electrically Erasable Programmable Read Only Memory (EEPROM), an Erasable Programmable Read-Only Memory (EPROM), a Static Random-Access Memory (SRAM), a Read-Only Memory (ROM), a magnetic memory, a flash memory, a Programmable Read-Only Memory (PROM).

In some embodiments, the receiver 1702 is configured to receive a control signaling, here, the control signaling is used for triggering the zero-power device to perform time-frequency synchronization, and indicating time-frequency resources for data transmission. In some embodiments, the receiver 1702 is also configured to perform other operations related to the processing regarding receiving in the method embodiments described above.

In some embodiments, the transmitter 1703 is configured to send a control signaling, here, the control signaling is used for triggering the zero-power device to perform time-frequency synchronization, and indicating time-frequency resources for data transmission. In some embodiments, the transmitter 1703 is also configured to perform other operations related to the processing regarding sending in the method embodiments described above.

In some embodiments, the receiver 1702 is configured to receive a control signaling, here, the control signaling is used for triggering the zero-power device to perform time-frequency synchronization, and indicating time-frequency resources for data transmission. In some embodiments, the processor 1701 is further configured to perform other operations related to the processing regarding measurements in the method embodiments described above.

In some embodiments, the receiver 1702 receives signals/data independently, or the processor 1701 controls the receiver 1702 to receive signals/data, or the processor 1701 requests the receiver 1702 to receive signals/data, or the processor 1701 cooperates with the receiver 1702 to receive signals/data.

In some embodiments, the transmitter 1703 sends signals/data independently, or the processor 1701 controls the transmitter 1703 to send signals/data, or the processor 1701 requests the transmitter 1703 to send signals/data, or the processor 1701 cooperates with the transmitter 1703 to send signals/data.

In some embodiments, the processor 1701 and the receiver 1702 may be implemented as one module, or the processor 1701 may be implemented as part of the receiver 1702.

In some embodiments, the receiver 1702 may be implemented as a receiver device. Optionally, the receiver device may or may not include the processor 1701.

In some embodiments, the processor 1701 and the transmitter 1703 may be implemented as one module, or the processor 1701 may be implemented as part of the transmitter 1703.

In some embodiments, the transmitter 1703 may be implemented as a transmitter device. Optionally, the transmitter device may or may not include a processor 1701.

In an exemplary embodiment, there is also provided a computer-readable storage medium having stored therein at least one instruction, at least one program, a code set, or an instruction set. Here, the at least one instruction, the at least one program, the code set, or the instruction set is loaded and executed by a processor to perform the data transmission method provided by each of the above-described method embodiments.

In an exemplary embodiment, there is provided a chip including a programmable logic circuit and/or program instructions. The chip is configured to perform the data transmission method provided by each of the above-described method embodiments based on the programmable logic circuit and/or program, when the chip runs on a communication device.

In an exemplary embodiment, there is also provided a computer program product that, when run on a processor of a computer device, causes the computer device to perform the data transmission methods described above.

In an exemplary embodiment, there is also provided a computer program including computer instructions that, when executed by a processor of a computer device, cause the computer device to perform the data transmission methods described above.

Those skilled in the art should recognize that in one or more of the examples described above, the functions described in the embodiments of the present disclosure may be implemented in hardware, software, firmware, or any combination thereof. When implemented using software, these functions may be stored in a computer readable medium or transmitted as one or more instructions or codes on a computer readable medium. The computer-readable medium includes computer storage medium and communication medium, here, the communication medium includes any medium that facilitates transfer of a computer program from one place to another place. The storage medium may be any available medium accessible by a general-purpose or special-purpose computer.

The above descriptions are only exemplary embodiments of the present disclosure, and are not intended to limit the present disclosure. Any modification, equivalent substitution, improvement, and the like made within the spirit and principles of the present disclosure should be included within the scope of protection of the present disclosure.

1. A data transmission method, performed by a zero-power device, the method comprising:
receiving a control signaling, wherein the control signaling is used for triggering the zero-power device to perform time-frequency synchronization and indicating time-frequency resources for data transmission.

2. The method of claim 1, wherein the control signaling comprises a first control signaling and a second control signaling; wherein
the first control signaling is used for triggering the zero-power device to perform the time-frequency synchronization; and
the second control signaling is used for indicating the time-frequency resources for the data transmission.

3. The method of claim 2, wherein the second control signaling is after the first control signaling.

4. The method of claim 2, wherein the first control signaling comprises at least one of:
a trigger signal;
information related to the time-frequency synchronization;
device information of a target device; or
information related to the second control signaling;
wherein the target device comprises a device that performs the data transmission with the zero-power device.

5. The method of claim 4, wherein the information related to the time-frequency synchronization is indicated by a field carried in the first control signaling from a plurality of candidate values, or indicated by a generation sequence used by the first control signaling from a plurality of candidate values.

6. The method of claim 4, wherein the information related to the second control signaling comprises at least one of:
a time-domain gap between the first control signaling and the second control signaling;
a monitoring time window for the second control signaling;
time-frequency resources for the second control signaling; or
a modulation manner for the second control signaling.

7. The method of claim 2, wherein at least one of the first control signaling or the second control signaling further comprises at least one of:
data content for the data transmission;
a data type for the data transmission; or
a modulation manner for the data transmission.

8. The method of claim 1, wherein the control signaling comprises a third control signaling; wherein
the third control signaling is used for simultaneously triggering the zero-power device to perform the time-frequency synchronization and indicating the time-frequency resources for the data transmission.

9. The method of claim 8, wherein the third control signaling comprises a first field and a second field; wherein
the first field is used for indicating information related to the time-frequency synchronization, and the second field is used for indicating the time-frequency resources for the data transmission.

10. The method of claim 8, wherein the third control signaling comprises a second field; wherein
the second field is used for indicating the time-frequency resources for the data transmission.

11. The method of claim 8, wherein the time-frequency resources for the data transmission comprise a time-domain gap between the data transmission and the third control signaling.

12. The method of claim 11, wherein the time-domain gap is indicated by a product of a first indication value carried in the third control signaling and a time granularity.

13. The method of claim 11, wherein the time-domain gap is indicated by a sum of a second indication value carried in the third control signaling and an offset value.

14. The method of claim 11, wherein the time-domain gap is indicated by a sum of a product and an offset value, the product being a product of a first indication value carried in the third control signaling and a time granularity.

15. The method of claim 11, wherein the time-domain gap is indicated by a third indication value carried in the third control signaling from a candidate value set.

16. The method of claim 12, wherein the time granularity, offset value, and candidate value set are preset, or pre-configured, or configured by a higher-layer signaling.

17. The method of claim 12, wherein a plurality of sets of candidate items exist, the candidate items comprising at least one of: the time granularity, offset value, or candidate value set, wherein the candidate item(s) used for determining the time-domain gap are determined based on at least one of:
a capability of the zero-power device;
data content for the data transmission;
a data type for the data transmission;
a modulation manner for the data transmission;
a type of a synchronization signal; or
an indication of a higher-layer signaling.

18. The method of claim 4, wherein the information related to the time-frequency synchronization comprises at least one of:
an accuracy requirement for the time-frequency synchronization;
a synchronization time for the time-frequency synchronization;
a modulation manner for the data transmission; or
a type of a synchronization signal.

19. A zero-power device, comprising:
a processor; and
a memory for storing instructions that, when executed the processor, cause the zero-power device to receive a control signaling, wherein the control signaling is used for triggering the zero-power device to perform time-frequency synchronization and indicating time-frequency resources for data transmission.

20. A network device, comprising:
a processor; and
a memory for storing instructions that, when executed by the processor, cause the network device to send a control signaling, wherein the control signaling is used for triggering a zero-power device to perform time-frequency synchronization and indicating time-frequency resources for data transmission.
